(19) United States
(12) Patent Application Publication
(10) Pub. No.: US 2017/0103714 A1
(43) Pub. Date: Apr. 13, 2017

(54) SEMICONDUCTOR DEVICE, DISPLAY DEVICE, AND ELECTRONIC DEVICE

(71) Applicant: Semiconductor Energy Laboratory Co., Ltd., Atsugi-shi (JP)

(72) Inventors: Roh YAMAMOTO, Atsugi (JP); Atsushi MIYAGUCHI, Hadano (JP)

(21) Appl. No.: 15/276,992

(22) Filed: Sep. 27, 2016

(30) Foreign Application Priority Data
Oct. 8, 2015 (JP) 2015-200272

(51) Int. Cl. G09G 3/34; G02F 1/1343; G02F 1/133; G09G 3/36; G09G 3/20

(52) U.S. Cl. CPC G09G 3/3413; G09G 3/3677; G09G 3/3696; G09G 3/2003; G02F 1/13306; G02F 1/13439; G09G 2300/0452; G02F 2001/134345; G09G 2300/0426; G09G 2310/0286; G09G 2320/0271; G09G 2320/0626; G09G 2330/021; G02F 1/133345

(57) ABSTRACT

A semiconductor device with a novel structure is provided. The amount of data supplied to the semiconductor device for driving a display device including different display elements is reduced, so that the circuit area is reduced and power consumption is reduced. In a driver circuit for driving the display device including different display elements, gradation data to be applied to the display elements is generated. The generated gradation data given to different display elements are configured to differ in accordance with the designed luminance based on gradation data to be displayed and the intensity of reflected light based on illuminance data. Because the amount of data from the exterior to the driver circuit can be reduced, low power consumption due to a reduction in the data transfer rate, and a reduction in the circuit area due to a reduction in the size of an interface can be achieved.

### TECHNICAL FIELD

One embodiment of the present invention relates to a semiconductor device, a display device, and an electronic device.

Note that one embodiment of the present invention is not limited to the above technical field. The technical field of the invention disclosed in this specification and the like relates to an object, a method, or a manufacturing method. Furthermore, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

In this specification and the like, a semiconductor device refers to an element, a circuit, a device, or the like that can function by utilizing semiconductor characteristics. An example of the semiconductor device is a semiconductor element such as a transistor or a diode. Another example of the semiconductor device is a circuit including a semiconductor element. Another example of the semiconductor device is a device provided with a circuit including a semiconductor element.

### BACKGROUND ART

Mobile devices such as smartphones have become increasingly popular. The mobile devices need to display images suitable for a use environment (i.e., an outdoor environment or an indoor environment).

For example, Patent Documents 1 to 3 each disclose a display device which performs display using reflected light in an outdoor environment and a light-emitting element in an indoor environment. Patent Documents 1 to 3 disclose that the improvement in display quality, low power consumption, the improvement in visibility, and the like can be achieved by the structures described in the documents.

### REFERENCE

### Patent Document

### [Patent Document 1] United States Patent Application Publication No. 2003/0107688

### [Patent Document 2] United States Published Patent Application No. 2006/0072047

### [Patent Document 3] Japanese Published Patent Application No. 2008-225381

### DISCLOSURE OF INVENTION

However, in the case of a display device including two display elements of a liquid crystal element utilizing reflected light and a light-emitting element such as an organic electroluminescence (EL) in a pixel, as gradation data that is supplied from a processor to a driver circuit, gradation data for driving the liquid crystal element and gradation data for driving the light-emitting element are needed. In that case, the amount of data is increased twice or more times the amount of data of a display device including a display element in a pixel. For example, when the amount of data that is supplied from a processor to a driver circuit is doubled, it becomes necessary to double an interface for transmitting a signal or double a transfer rate of the signal, leading to problems such as an increase in the area of a circuit and an increase in power consumption.

Alternatively, in a display device in which a liquid crystal element and a light-emitting element are combined and display is performed by switching between the liquid crystal element and the light-emitting element in accordance with brightness of the surrounding environment, though excellent visibility is obtained in a bright place such as a place exposed to direct sunlight or in a dark place such as a place under the moonlight, visibility is not enough in a dim place such as in a room or in a slightly bright place such as in a shade in the outdoors.

In view of the above, an object of one embodiment of the present invention is to provide a novel semiconductor device that has a structure different from that of an existing semiconductor device or the like, a novel display device, a novel electronic device, or the like.

Alternatively, an object of one embodiment of the present invention is to provide a semiconductor device or the like with a novel structure and a small circuit area. Another object of one embodiment of the present invention is to provide a semiconductor device or the like with a novel structure, in which power consumption is reduced. Another object of one embodiment of the present invention is to provide a novel semiconductor device or the like with improved visibility.

Note that the objects of one embodiment of the present invention are not limited to the above objects. The objects described above do not disturb the existence of other objects. The other objects are the ones that are not described above and will be described below. The other objects will be apparent from and can be derived from the description of the specification, the drawings, and the like by those skilled in the art. One embodiment of the present invention is to solve at least one of the aforementioned objects and the other objects.

One embodiment of the present invention is a semiconductor device including a first circuit, a second circuit, and a third circuit. The first circuit is configured to generate a third signal and a fourth signal in accordance with a first signal and a second signal. The second circuit is configured to hold the third signal and the fourth signal. The third circuit is configured to execute digital-to-analog conversion of the third signal and the fourth signal to output signals. The first signal is illuminance data. The second signal is gradation data. The third signal is liquid crystal gradation data for driving a liquid crystal element. The fourth signal is light-emitting element gradation data for driving a light-emitting element.

One embodiment of the present invention is a semiconductor device including a first circuit, a second circuit, and a third circuit. The first circuit is configured to generate a third signal and a fourth signal in accordance with a first signal and a second signal. The second circuit is configured to hold the third signal and the fourth signal. The third circuit is configured to execute digital-to-analog conversion of the third signal and the fourth signal to output signals. The first signal is illuminance data. The second signal is gradation data. The third signal is liquid crystal gradation data for driving a liquid crystal element. The fourth signal is light-emitting element gradation data for driving a light-emitting element. The first circuit is configured to vary a ratio of luminance based on the liquid crystal gradation data to luminance based on the light-emitting element gradation data depending on the size of the illuminance data.

One embodiment of the present invention is a semiconductor device including a first circuit, a second circuit, and a third circuit. The first circuit is configured to generate a third signal and a fourth signal in accordance with a first signal and a second signal. The second circuit is configured to hold the third signal and the fourth signal. The third circuit is configured to execute digital-to-analog conversion of the third signal and the fourth signal to output signals. The first signal is illuminance data. The second signal is gradation data. The third signal is liquid crystal gradation data for driving a liquid crystal element. The fourth signal is light-emitting element gradation data for driving a light-emitting element. The first circuit is configured to estimate designed luminance based on the gradation data, estimate reflected light luminance in accordance with the size of the illuminance data, and vary a ratio of luminance based on the liquid crystal gradation data to luminance based on the light-emitting element gradation data depending on the magnitude relationship between the designed luminance and the reflected light luminance.

One embodiment of the present invention is a display device comprising any of the semiconductor devices and a pixel portion. The pixel portion includes a pixel. The pixel includes the light-emitting element and the liquid crystal element including a reflective electrode.

In one embodiment of the present invention, the liquid crystal element and the light-emitting element are preferably provided to overlap with each other.

Note that other embodiments of the present invention will be described in the following embodiments with reference to the drawings.

One embodiment of the present invention can provide a novel semiconductor device, a novel display device, a novel electronic device, or the like.

One embodiment of the present invention can provide a semiconductor device or the like with a novel structure and a small circuit area. Another embodiment of the present invention can provide a semiconductor device or the like with a novel structure, in which power consumption is reduced. One embodiment of the present invention can provide a semiconductor device or the like with a novel structure and high visibility.

Note that the effects of one embodiment of the present invention are not limited to the above effects. The effects described above do not disturb the existence of other effects. The other effects are the ones that are not described above and will be described below. The other effects will be apparent from and can be derived from the description of the specification, the drawings, and the like by those skilled in the art. One embodiment of the present invention is to have at least one of the aforementioned effects and the other effects. Accordingly, one embodiment of the present invention does not have the aforementioned effects in some cases.

### BRIEF DESCRIPTION OF THE DRAWINGS

In the accompanying drawings:

FIGS. 1A and 1B are block diagrams illustrating one embodiment of the present invention;

FIG. 2 is a flow chart illustrating one embodiment of the present invention;

FIGS. 3A to 3D are graphs illustrating one embodiment of the present invention;

FIGS. 4A to 4C are circuit diagrams each illustrating one embodiment of the present invention;

FIGS. 5A and 5B are block diagrams each illustrating one embodiment of the present invention;

FIG. 6 is a block diagram illustrating one embodiment of the present invention;

FIGS. 7A and 7B are block diagrams each illustrating one embodiment of the present invention;

FIGS. 8A and 8B are block diagrams each illustrating one embodiment of the present invention;

FIGS. 9A and 9B are a block diagram and a circuit diagram illustrating one embodiment of the present invention;

FIGS. 10A to 10D are circuit diagrams each illustrating one embodiment of the present invention;

FIGS. 11A to 11C are a circuit diagram and layout diagrams illustrating one embodiment of the present invention;

FIGS. 12A and 12B are a schematic cross-sectional view and a perspective view illustrating one embodiment of the present invention;

FIG. 13 is a schematic cross-sectional view illustrating one embodiment of the present invention;

FIGS. 14A to 14C are schematic cross-sectional views illustrating one embodiment of the present invention;

FIGS. 15A1, 15A2, 15B1, 15B2, 15C1, and 15C2 are schematic cross-sectional views illustrating one embodiment of the present invention;

FIGS. 16A1, 16A2, 16A3, 16B1, and 16B2 are schematic cross-sectional views illustrating one embodiment of the present invention;

FIGS. 17A1, 17A2, 17A3, 17B1, 17B2, 17C1, and 17C2 are schematic cross-sectional views illustrating one embodiment of the present invention;

FIG. 18 is a schematic cross-sectional view illustrating one embodiment of the present invention;

FIGS. 19A and 19B are schematic views each illustrating one embodiment of the present invention;

FIG. 20 is a perspective view illustrating one embodiment of the present invention;

FIGS. 21A to 21E each illustrate an electronic device of one embodiment of the present invention;

FIGS. 22A to 22F are graphs illustrating one embodiment of the present invention; and

FIGS. 23A and 23B are a block diagram and a waveform diagram illustrating one embodiment of the present invention.

### BEST MODE FOR CARRYING OUT THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

In this specification and the like, ordinal numbers such as first, second, and third are used in order to avoid confusion among components. Thus, the terms do not limit the number or order of components. Thus, the terms do not limit the number or order of components. In the present specification and the like, a “first” component in one embodiment can be referred to as a “second” component in other embodiments or claims. Furthermore, in the present specification and the like, a “first” component in one embodiment can be referred to without the ordinal number in other embodiments or claims.

The same elements or elements having similar functions, elements formed using the same material, elements formed at the same time, or the like in the drawings are denoted by the same reference numerals, and the description thereof is not repeated in some cases.

### Embodiment 1

In this embodiment, an example of a semiconductor device that functions as a driver circuit of a display device will be described. Note that the driver circuit is also referred to as a driver IC, a source driver IC, or a controller driver IC.

### <Structure of Semiconductor Device>

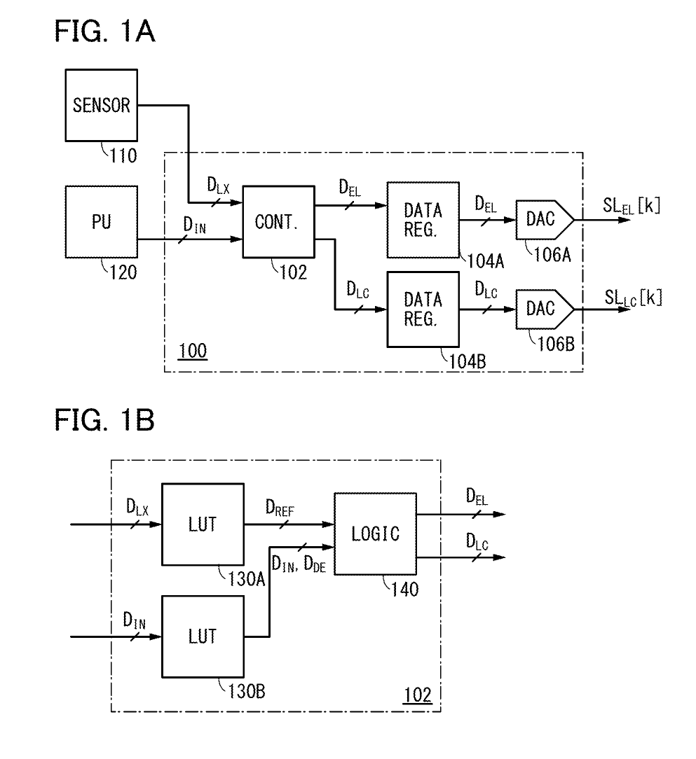

FIG. 1A is an example of a block diagram illustrating a semiconductor device.

A semiconductor device 100 in FIG. 1A includes a controller 102 (denoted by CONT.), data registers 104A and 104B (denoted by DATA REG.), and digital analog converters 106A and 106B (denoted by DAC).

In the block diagram in FIG. 1A, in addition to the semiconductor device 100, a processor 120 (denoted by PU) and a sensor 110 (denoted by SENSOR) are illustrated. A signal D_{LX} is supplied from the sensor 110 to the controller 102. The signal D_{LX} is data corresponding to the intensity of illuminance based on the intensity of external light, for example, or data corresponding to the intensity of luminance. A signal D_{IN} is supplied from the processor 120 to the controller 102. The signal D_{IN} is gradation data for displaying an image in a pixel, for example.

The semiconductor device 100 outputs, based on the signals D_{LX} and D_{IN}, gradation voltages corresponding to signals D_{LC} and D_{EL} including gradation data, to a pixel of a display device including two display elements in the pixel. The signal D_{LC} corresponds to gradation data for generating a gradation voltage to be applied to a liquid crystal element, for example. Note that the liquid crystal element is an element which includes a reflective electrode and controls luminance by controlling the reflectance. The signal D_{EL} corresponds to gradation data for generating a gradation voltage to be applied to a light-emitting element, for example. Note that the light-emitting element includes a light-emitting portion and controls the intensity of light emitted from the light-emitting portion to control luminance. Note that the signal D_{LC} is referred to as liquid crystal gradation data for driving the liquid crystal element in some cases. Furthermore, the signal D_{EL} is referred to as light-emitting element gradation data for driving the light-emitting element in some cases.

In FIG. 1A, the semiconductor device 100 outputs gradation voltages corresponding to the signals D_{LC} and D_{EL} to signal lines SL_{LC}[k] and SL_{EL}[k], respectively, which are connected to pixels in a k-th column (k is a natural number). For that reason, in FIG. 1A, two data registers and two digital analog converters which correspond to one pixel are shown. Although in this embodiment, an example of application to a pixel including two display elements is described, application to a pixel including three or more display elements is possible.

A controller 102 is a circuit that generates the signals D_{LC} and D_{EL} based on the signals D_{LX} and D_{IN}. The controller 102 is simply referred to as a circuit in some cases. The controller 102 adjusts, in accordance with the signal D_{LX}, the ratio of luminance based on the signal D_{LC} to luminance based on the signal D_{EL} so that gradation display based on the signal D_{IN} is performed. Specifically, designed luminance based on gradation data is estimated and reflected light luminance of a pixel in accordance with the magnitude of the signal D_{LX} corresponding to illuminance data is estimated; then, in accordance with the magnitude relationship between the designed luminance and the reflected light luminance, the ratio of the luminance based on the signal D_{LC} to the luminance based on the signal D_{EL} is adjusted. Note that the signals D_{LX}, D_{IN}, D_{LC}, and D_{EL} are preferably digital signals in order to facilitate arithmetic processing and the like.

Note that the designed luminance corresponds to luminance based on light emitted to a viewer side in accordance with gradation data when an image is displayed in a pixel. The reflected light luminance is luminance based on light emitted to the viewer side by reflected light of external light. For example, when the reflected light luminance is high, the ratio of luminance of the signal D_{EL} to luminance of the signal D_{LC} is made small so that desired designed luminance is obtained. In an opposite manner, when the reflected light luminance is low, the ratio of the luminance of the signal D_{EL} to the luminance of the signal D_{LC} is made large so that desired designed luminance is obtained. In such a manner, luminance adjustment by the signal D_{EL} can be performed in accordance with the reflected light luminance; accordingly, excellent visibility can be obtained in a bright place such as a place exposed to direct sunlight, in a dark place such as a place under the moonlight, in a dim place such as in a room, or in a slightly bright place such as in a shade in the outdoors.

The amount of data from the processor 120 being outside to the semiconductor device 100 can be reduced by the function of the controller 102. Thus, low power consumption can be achieved by a reduction in a data transfer rate between the processor 120 and the semiconductor device 100. By the reduction in the amount of data, an interface connecting circuits to each other can be made small and thus the circuit area can be reduced.

The data registers 104A and 104B are circuits holding data based on the signals D_{LC} and D_{EL}. The data registers 104A and 104B are simply referred to as circuits in some cases. The data registers 104A and 104B are circuits outputting gradation data D_{LC} and D_{EL} to the digital analog converters 106A and 106B by control signals.

The digital analog converters 106A and 106B generate gradation voltages that are analog signals corresponding to the signals D_{LC} and D_{EL} that are digital signals and output the gradation voltages to the signal lines SL_{LC}[k] and SL_{EL}[k] connected to the pixels in the k-th column. The digital analog converters 106A and 106B are simply referred to as circuits in some cases.

Note that the structure of the semiconductor device 100 is not limited to that illustrated in FIG. 1A, and the semiconductor device 100 may further include a level shifter circuit, an output buffer circuit, or the like. Alternatively, any of the data registers 104A and 104B and the digital analog converters 106A and 106B may be omitted.

Next, FIG. 1B illustrates an example of a block diagram of the controller 102. The controller 102 includes look up tables (indicated by LUT) 130A and 130B and an arithmetic circuit 140 (indicated by LOGIC).

The look up table 130A estimates a signal D_{REF} including data on reflected light luminance of a pixel in accordance with the magnitude of the signal D_{LX} corresponding to illuminance data and outputs the signal D_{REF} to the arithmetic circuit 140. The signal D_{LX} corresponding to illuminance data is desirably a digital signal for easy conversion. The signal D_{REF} that is output is a digital signal.

The look up table 130B estimates a signal D_{DE} including data on designed luminance of a pixel in accordance with the magnitude of the signal D_{IN} corresponding to gradation data and outputs the signal D_{DE}, together with the signal D_{IN}, to the arithmetic circuit 140. The signal D_{IN} corresponding to gradation data is desirably a digital signal for easy conversion. The signal D_{DE} that is output is a digital signal.

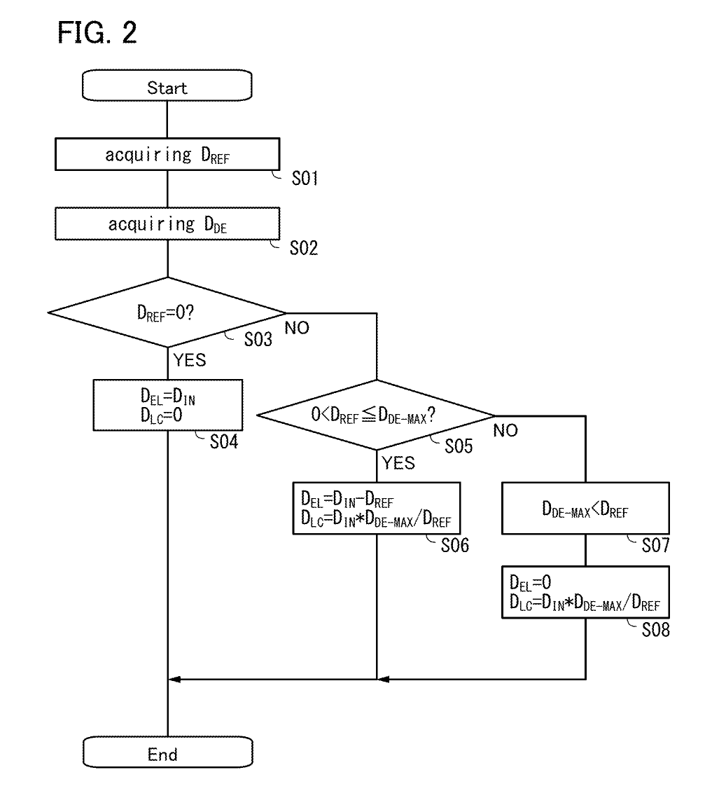

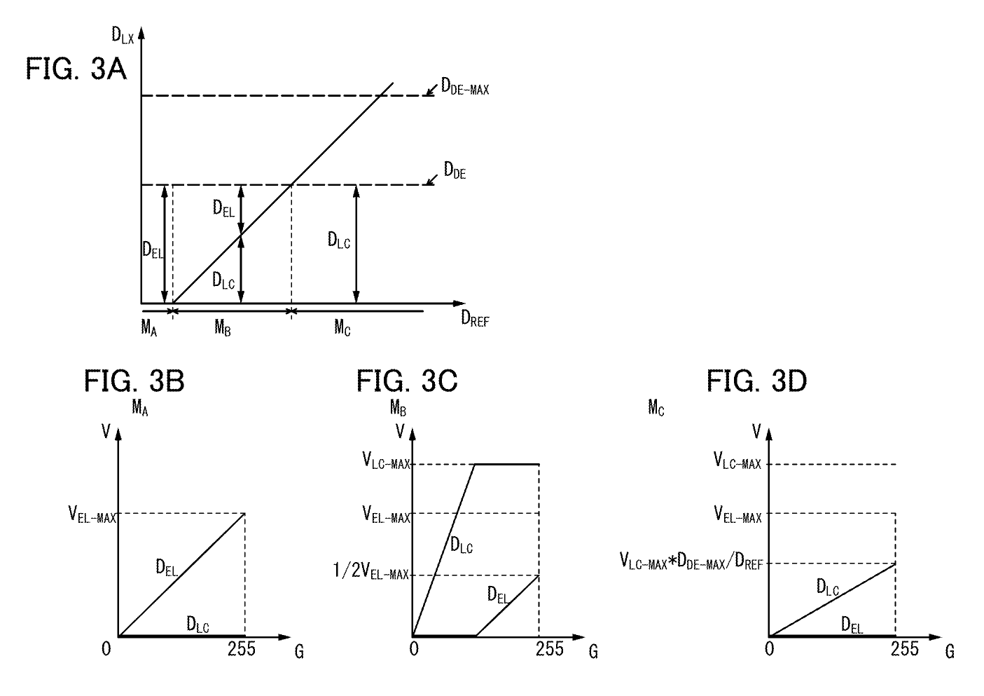

The arithmetic circuit 140 can estimate the signals D_{LC} and D_{EL} from the signals D_{REF}, D_{IN}, and D_{DE} along the flow chart in FIG. 2. The proportion of luminance based on the signals D_{LC} and D_{EL} estimated by the arithmetic circuit 140 is classified by the relationship between the magnitude of the signal D_{REF} including data on reflected light luminance and the magnitude of the maximum value D_{DE-MAX} of the signal D_{DE} including data on designed luminance. The ratios can be explained by the graphs illustrated in FIGS. 3A to 3D.

First, the flow chart in FIG. 2 is described. In step S01, the signal D_{REF} including data on reflected light luminance of a pixel is acquired in accordance with the magnitude of the signal D_{LX} corresponding to illuminance data. Then, in step S02, the signal D_{DE} including data on designed luminance of the pixel is acquired in accordance with the magnitude of the signal D_{IN} corresponding to gradation data.

Next, in step S03, whether D_{REF}=0 is determined. When D_{REF}=0, the process proceeds to step S04. Because external light reflection does not contribute to the designed luminance, the following formulae: D_{LC}=0 and D_{EL}=D_{IN} are set, and the signal D_{EL} corresponding to gradation data is set based on the signal D_{IN} so that the designed luminance is obtained from the luminance of a light-emitting element. When D_{REF} is not 0, the process proceeds to a determination in step S05.

Next, in step S05, whether 0<D_{REF}≦D_{DE-MAX} is determined. When 0<D_{REF}≦D_{DE-MAX}, the process proceeds to step S06. Because external light reflection contributes to the designed luminance, the following formulae: D_{EL}=D_{IN}−D_{REF} and D_{LC}=D_{IN}*D_{DE-MAX}/D_{REF} are set, and a signal corresponding to gradation data is set so that the designed luminance is obtained from both the luminance of a light-emitting element and the luminance of a liquid crystal element utilizing reflected light. That is, the signals D_{LC} and D_{EL} are set so that the luminance of the light-emitting element compensates for insufficient luminance of the luminance of the liquid crystal element utilizing reflected light. When 0<D_{REF}≦D_{DE-MAX} does not hold, the process proceeds to step S07.

Next, in step S07, whether D_{DE-MAX}<D_{REF} is determined. In step S08, because external light reflection contributes to the designed luminance to an excessive degree, the following formulae: D_{EL}=0 and D_{LC}=D_{IN}*D_{DE-MAX}/D_{REF} are set, and gradation data is set so that the designed luminance is obtained by eliminating the luminance of the light-emitting element and making the luminance of the liquid crystal element utilizing reflected light smaller than that of the signal D_{IN} corresponding to the original gradation data. That is, because the luminance of the liquid crystal element utilizing reflected light is larger than the designed luminance, the signals D_{LC} and D_{EL} are set so that the designed luminance by the liquid crystal element utilizing reflected light is obtained by making the signal D_{IN} corresponding to the original gradation data small.

The graph in FIG. 3A shows the relationship between the signal D_{REF} and the signal D_{LX}. The relationship between them is a proportional relationship. The graph in FIG. 3A shows the signal D_{DE} of the designed luminance and the maximum value D_{DE-MAX} of the signal D_{DE}. For example, when the signal D_{IN} that is input is 8-bit gradation data, the maximum value D_{DE-MAX} of the designed luminance in FIG. 3A is 255, the maximum value of the gradation value, and the gradation value of the signal D_{DE} of the designed luminance shown in FIG. 3A is 128.

In the case where the gradation value of the signal D_{DE} of the designed luminance, 128, is expressed by the signals D_{LC} and D_{EL}, the ratio of the signal D_{LC} to the signal D_{EL} is different even with the same designed luminance depending on the level of the reflected light luminance.

For example, as indicated by D_{REF}=0, the case where the signal D_{REF} including data on the reflected light luminance is small is referred to as Period M_{A}, external reflection rarely contributes to the designed luminance in Period M_{A}. Thus, the following formulae: D_{LC}=0 and D_{EL}=D_{IN} are set and the signals D_{LC} and D_{EL} are set so that the designed luminance is obtained from luminance of the light-emitting element as shown in FIG. 3B. Note that in FIG. 3B, the horizontal axis represents a gradation value where 255 is the maximum value, and the vertical axis represents a voltage. The gradation voltage is increased by an increase in the signal D_{EL} based on gradation data of the light-emitting element. The maximum gradation voltage is V_{EL-MAX}.

Alternatively, as indicated by 0<D_{REF}≦D_{DE-MAX}, the case where the signal D_{REF} including data on reflected light luminance is less than or equal to the maximum value D_{DE-MAX} of the designed luminance is referred to as Period MB. Because external light reflection contributes to the designed luminance in Period MB, as shown in FIG. 3C, the signals D_{LC} and D_{EL} are set so that the designed luminance is expressed by luminance of the liquid crystal element on the lower gray scale side and the light-emitting element on the higher gray scale side compensates for insufficient luminance of the luminance of the liquid crystal element. Note that in FIG. 3C, the horizontal axis represents a gradation value where 255 is the maximum value, and the vertical axis represents a voltage. The gradation voltage is applied by the signal D_{LC} based on the gradation data of the liquid crystal element on the lower gray scale side, thereby expressing the designed luminance. When the gradation voltage to be applied to the liquid crystal element becomes the maximum (V_{LC-MAX}), the signal D_{EL} based on the gradation data of the light-emitting element is increased to compensate for the deficiencies in luminance, thereby expressing the desired luminance.

Alternatively, as indicated by D_{DE-MAX}<D_{REF}, the case where the signal D_{REF} including data on reflected light luminance is greater than the maximum value of D_{DE-MAX} is referred to as Period M_{C}. External light reflection contributes to the designed luminance to an excessive degree in Period M_{C}, and the luminance of the liquid crystal element utilizing reflected light is higher than the designed luminance. Thus, as shown in FIG. 3D, the designed luminance is expressed by the signal D_{LC} that has a voltage level lower than a voltage V_{LC-MAX}. Note that in FIG. 3D, the horizontal axis represents a gradation value where 255 is the maximum value, and the vertical axis represents a voltage. The gradation voltage is increased by an increase in the signal D_{LC} based on the gradation data of the liquid crystal element; the maximum gradation voltage is a value obtained by dividing the maximum value of the designed luminance D_{DE-MAX} by the signal of the reflected light luminance.

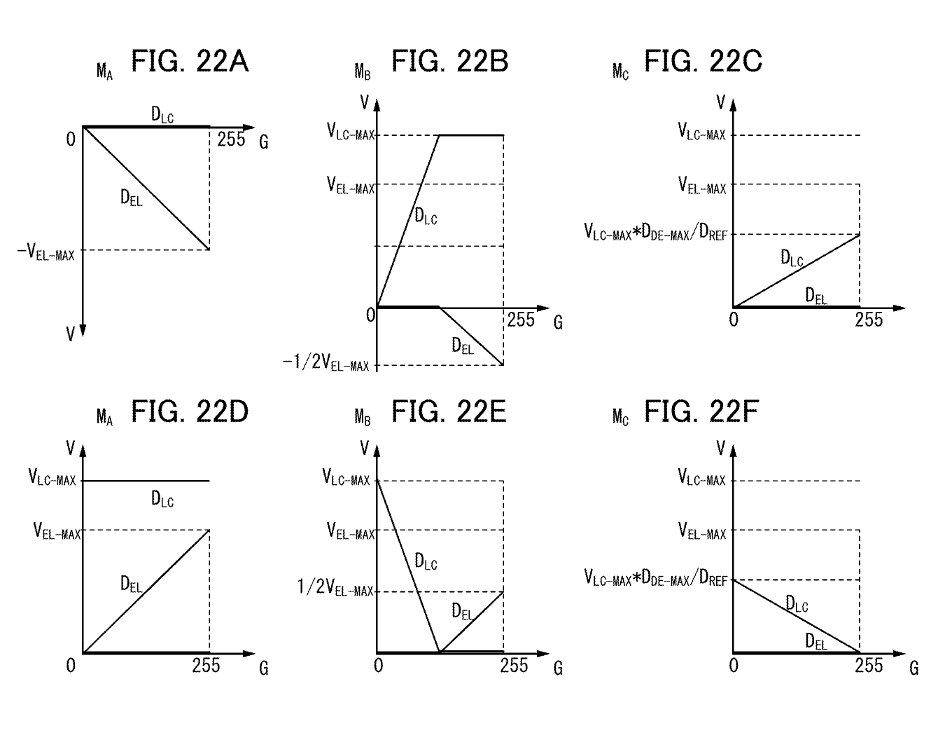

In the above description, although a driving transistor of the light-emitting element is an n-channel transistor and the liquid crystal element is normally black, one embodiment of the present invention is not limited to this. For example, the driving transistor of the light-emitting element may be a p-channel transistor. In that case, graphs corresponding to FIGS. 3A to 3C in Period M_{A} to Period M_{C} are shown in FIGS. 22A to 22C. Further alternatively, the liquid crystal element may be normally white. In that case, graphs corresponding to FIGS. 3A to 3C in Period M_{A} to Period M_{C} are shown in FIGS. 22D to 22F. When inversion driving is performed in the liquid crystal element, a voltage applied to the liquid crystal element is inverted to a common voltage that is a reference.

As described above, the arithmetic circuit 140 can estimate the signals D_{LC} and D_{EL} based on gradation data from the signals D_{REF}, D_{IN}, and D_{DE}. The set signals D_{LC} and D_{EL} can reduce the proportion of light emission of the light-emitting element when the signal of the reflected light luminance is high; thus, visibility in a dim place such as in a room or in a slightly bright place such as in a shade in the outdoors is improved and low power consumption can be achieved.

### <Structure Example of Sensor>

Next, an example of the sensor 110 that supplies the signal D_{LX} shown in FIG. 1A is described.

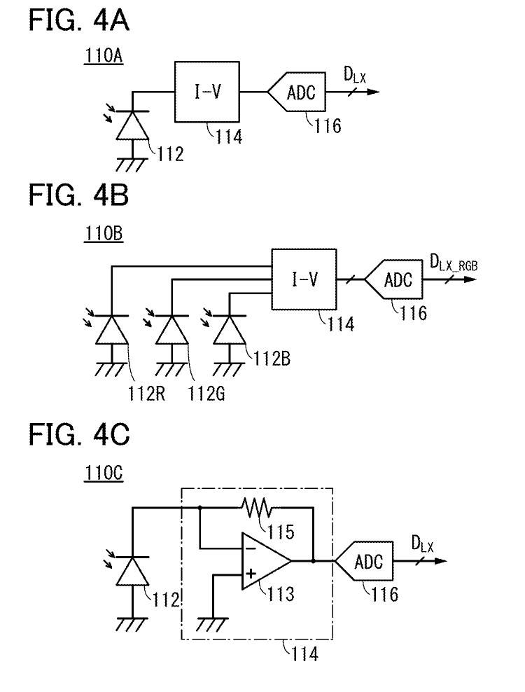

FIGS. 4A to 4C each illustrate an example of a circuit diagram of a sensor.

A sensor 110A illustrated in FIG. 4A includes a photoelectric conversion element 112, a current-voltage converter circuit 114 (indicated by I-V), and an analog digital converter 116 (indicated by ADC).

In FIG. 4A, a photodiode is illustrated as the photoelectric conversion element 112; however, another photoelectric conversion element may be used. For example, a diode-connected transistor may be used. Alternatively, a variable resistor or the like utilizing a photoelectric effect may be formed using silicon, germanium, selenium, or the like.

Furthermore, like a sensor 110B shown in FIG. 4B, photodiodes 112R, 112G, and 112B corresponding to RGB (red, green, and blue) may be provided. The semiconductor device 100 can generate the signals D_{LC} and D_{EL} based on gradation data in accordance with a change in illuminance of each color by acquiring the illuminance data of each color as a signal D_{LX}_{_}_{RGB}.

The current-voltage converter circuit 114 is configured to include a combination of an amplifier 113 and a resistor 115 like the sensor 110B illustrated in FIG. 4B. The analog digital converter 116 can be a flash type, a delta-sigma type, a pipeline type, an integration type, or a successive approximation type, for example.

### <Modification Example of Semiconductor Device>

Next, an example of the semiconductor device 100 in FIG. 1A is described.

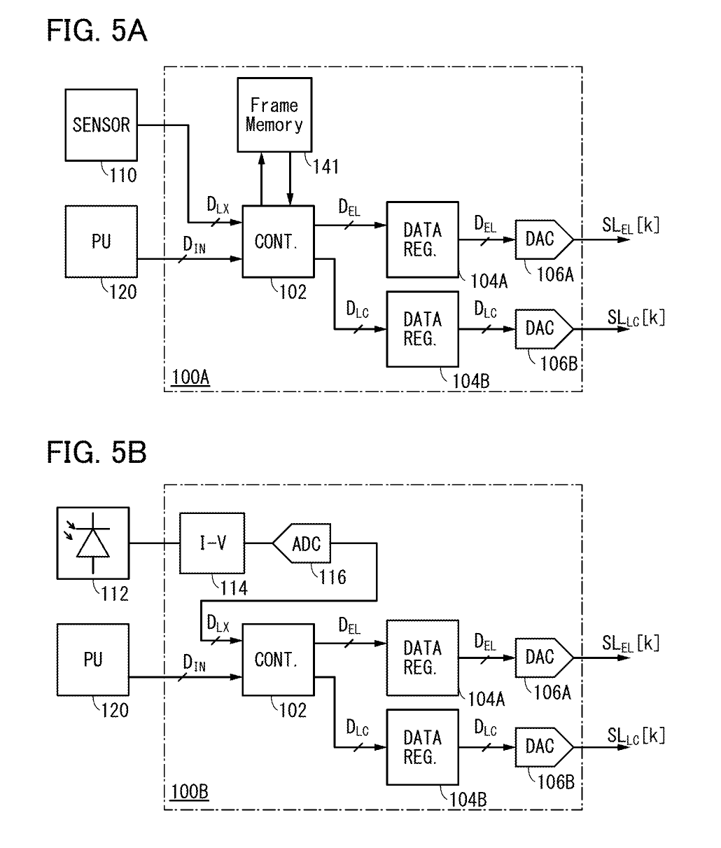

FIGS. 5A and 5B are examples of a block diagram illustrating a modification example of the semiconductor device.

A semiconductor device 100A in FIG. 5A includes a frame memory 141 (indicated by Frame Memory) in addition to the components of the semiconductor device 100 in FIG. 1A.

As described above, in one embodiment of the present invention, the amount of data from the processor 120 to the semiconductor device 100 can be reduced by the function of the controller 102. Thus, in addition to a reduction in a data transfer rate between the processor 120 and the semiconductor device 100 or a reduction in the size of an interface connecting circuits to each other, the memory capacity of the frame memory 141 can be reduced due to a reduction in the amount of data held in the semiconductor device 100. Consequently, in addition to the reduction in the size of the interface, an advantage of the reduction in the circuit area is significant.

A semiconductor device 100B in FIG. 5B includes in addition to the components of the semiconductor device 100 in FIG. 1A, the photoelectric conversion element 112, the current-voltage converter circuit 114, and the analog digital converter 116 which are described in FIG. 4A.

As shown in FIG. 5B, because the current-voltage converter circuit 114 and the analog digital converter 116 are circuits formed of semiconductor elements, they can be provided in the semiconductor device 100B.

### <Semiconductor Device and Peripheral Circuit>

Next, a block diagram including the semiconductor device 100 in FIG. 1A, an external circuit portion provided with the processor 120, and a peripheral circuit such as a pixel portion is described.

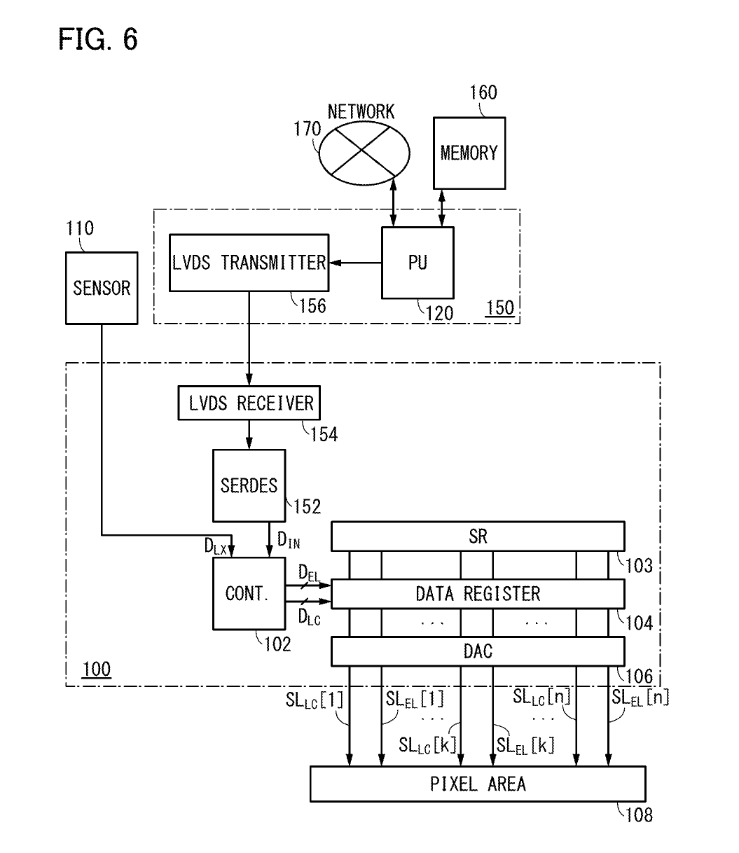

FIG. 6 is an example of the block diagram illustrating the semiconductor device and the peripheral circuit.

FIG. 6 illustrates, in addition to the components described in FIGS. 1A and 1B (the controller 102, the data register 104 (104A and 104B), the digital analog converter 106 (106A and 106B), the sensor 110, and the processor 120), a shift register 103 (indicated by SR), a pixel portion 108 (indicated by PIXEL AREA), a serial-parallel conversion circuit 152 (indicated by SERDES), a low voltage differential signaling (LVDS) receiver 154 (indicated by LVDS RECEIVER), an LVDS transmitter 156 (indicated by LVDS TRANSMITTER), a memory device 160 (indicated by MEMORY), and an external communication means 170 (indicated by NETWORK).

The shift register 103 is a circuit that outputs a timing signal for sequentially holding the signals D_{LC} and D_{EL} in the data register 104 at a predetermined timing.

The pixel portion 108 includes pixels (not shown) arranged in m rows and n columns (each of n and m is a natural number). When a pixel is provided in a j-th row and a k-th column (j is a natural number less than or equal to m, and k is a natural number less than or equal to n) as a pixel in an arbitrary row and an arbitrary column, FIG. 6 shows a signal line SL_{LC}[1], a signal line SL_{EL} [1], a signal line SL_{LC} [k], a signal line SL_{EL} [k], a signal line SL_{LC} [n], and a signal line SL_{EL}[n].

The LVDS receiver 154 and the LVDS transmitter 156 are an interface for generating the signal D_{IN} including gradation data in the processor 120 on an external circuit board 150 side and supplying it to the semiconductor device 100 that is a driver circuit. The signal D_{IN} converted into a differential signal in the LVDS transmitter 156 is converted into a single-ended signal in the LVDS receiver 154. The serial-parallel conversion circuit 152 is a circuit for converting the signal D_{IN} into parallel data or serial data depending on data and outputting it to the controller 102.

In FIG. 6, the memory device 160 and the external communication means 170 are each configured to supply image data for generating the signal D_{IN}. The image data stored via the network or in the memory device is converted into the signal D_{IN} in the processor 120 and is supplied to the semiconductor device 100 side.

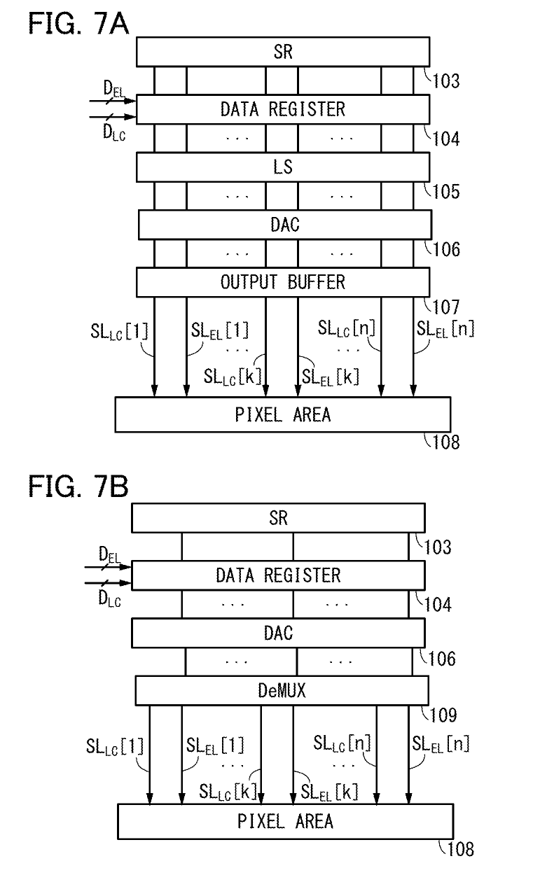

Note that in the semiconductor device 100, a structure between the data register 104 and the pixel portion 108 can be changed as appropriate. For example, as shown in FIG. 7A, a level shifter 105 (indicated by LS) may be provided between the data register 104 and the digital analog converter 106. Such a structure enables a signal to be transmitted from a circuit that operates at a low voltage to a circuit that operates at a high voltage without a malfunction. Alternatively, as shown in FIG. 7A, an output buffer 107 (indicated by OUTPUT BUFFER) may be provided between the digital analog converter 106 and the pixel portion 108. Such a structure enables a high-accuracy analog voltage to be output to the signal line SL_{LC} [1], the signal line SL_{EL} [1], the signal line SL_{LC} [k], the signal line SL_{EL} [k], the signal line SL_{LC} [n], and the signal line SL_{EL}[n] that have large loads.

Alternatively, as shown in FIG. 7B, a demultiplexer 109 (indicated by DeMUX) may be provided between the digital analog converter 106 and the pixel portion 108. Such a structure enables the number of wirings among the shift register, the data register, and the digital analog converter 106 to be reduced compared to the number of pixel columns.

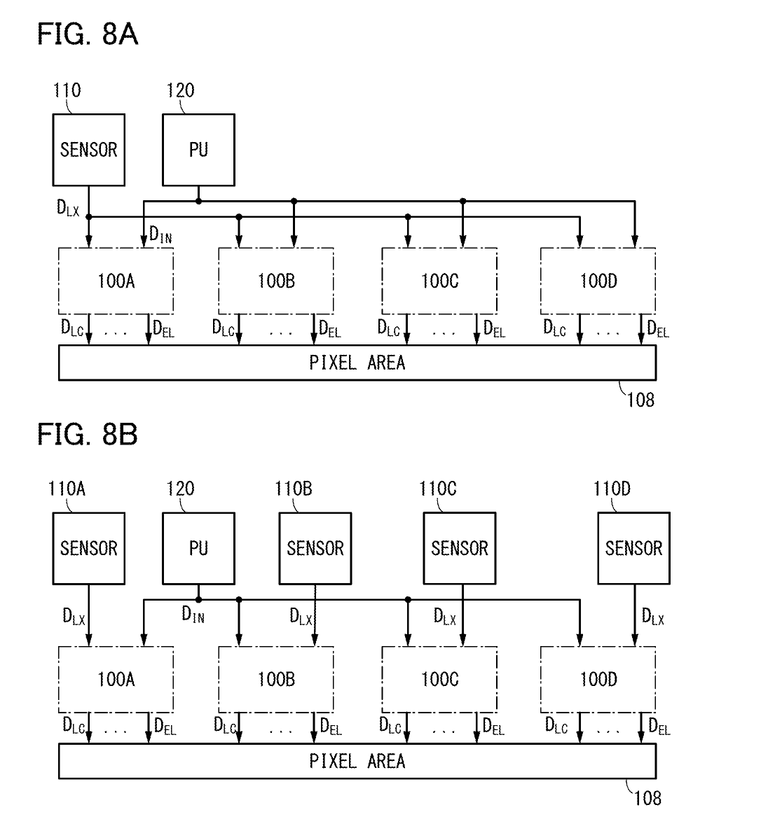

In the case where the number of pixel columns is large, a plurality of semiconductor devices 100 may be arranged to the pixel portion 108. A block diagram in that case is shown in FIG. 8A. In FIG. 8A, an example is illustrated in which semiconductor devices 100A to 100D are arranged to the pixel portion 108. To each of the semiconductor devices 100A to 100D, the signal D_{LX} and the signal D_{IN} are supplied from the sensor 110 and the processor 120, respectively. With such a structure, the structure of one embodiment of the present invention can be applied also in the case where the number of pixels is increased.

Note that a plurality of sensors 110 may be arranged corresponding to the semiconductor devices 100A to 100D. A block diagram in that case is shown in FIG. 8B. In FIG. 8B, sensors 110A to 110D are arranged corresponding to the semiconductor devices 100A to 100D. With such a structure, the signal D_{LX} is acquired by the sensor for each region where an image is displayed on the semiconductor device, and the signals D_{LC} and D_{EL} can be generated.

### <Structure Example of Display Device>

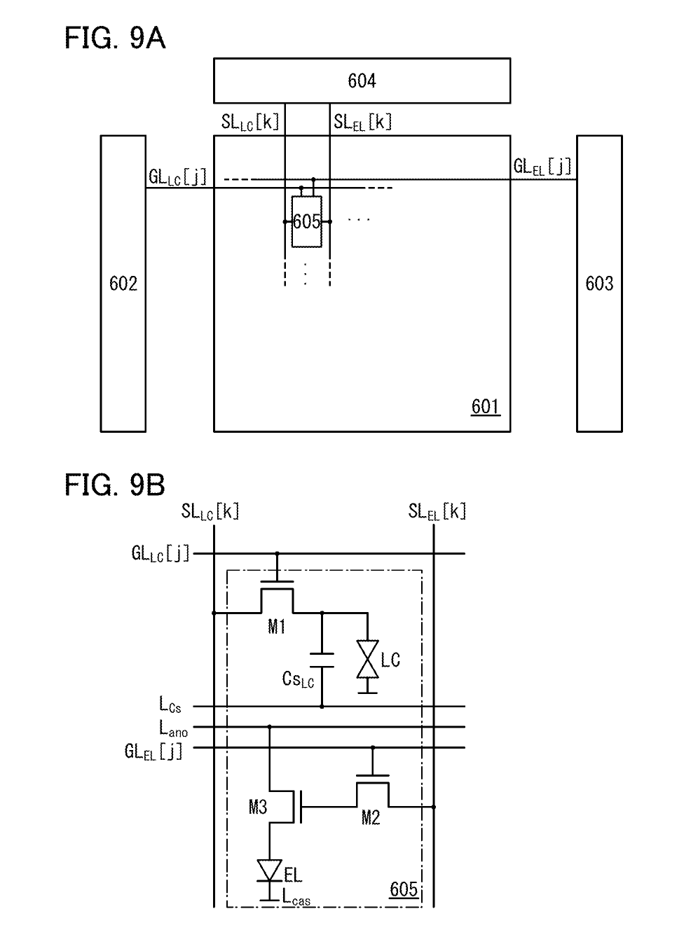

A display device including the above semiconductor device and a pixel portion is described. FIG. 9A is an example of a block diagram of the display device. FIG. 9A illustrates a pixel portion 601, a gate line driver circuit 602, a gate line driver circuit 603, and a signal line driver circuit 604. The semiconductor device 100 corresponds to the signal line driver circuit 604.

The pixel portion 601 includes a plurality of pixels arranged in m rows and n columns (each of n and m is a natural number). In FIG. 9A, the pixel provided in a j-th row and a k-th column (j is a natural number less than or equal to m, and k is a natural number less than or equal to n) is denoted by a pixel 605 as a pixel in an arbitrary row and an arbitrary column.

The pixel 605 can be applied not only to a pixel that drives a display device for monochrome display but also to a pixel that drives a display device for color display. When color display is performed, the pixel 605 corresponds to subpixels where color elements have three colors of RGB (R, G, and B correspond to red, green, and blue, respectively). The number of subpixels in one pixel is not limited to three. For example, one pixel may include four subpixels: an R subpixel, a G subpixel, a B subpixel, and a W (white) subpixel. Alternatively, a color element may be composed of two colors among R, G, and B as in PenTile layout. The two colors may differ among color elements. Alternatively, one or more colors of yellow, cyan, magenta, and the like may be added to RGB.

In the case of pixels of the display device for color display, the occupied area, the shape, or the like of the pixel of each color may be the same or different. As arrangement of the pixels, stripe arrangement or matrix arrangement can be used. In addition, delta arrangement, Bayer arrangement, pentile arrangement, or the like may be used.

The gate line driver circuit 602 has a function of transmitting a scanning signal to a gate line GL_{LC}[j]. The gate line GL_{LC}[j] transmits the scanning signal output from the gate line driver circuit 602 to the pixel 605. The scanning signal supplied to the gate line GL_{LC}[j] is a signal for writing gradation voltage supplied to the signal line SL_{LC} [k] into the pixel.

The gate line driver circuit 603 has a function of transmitting a scanning signal to a gate line GL_{EL}[j]. The gate line GL_{EL}[j] transmits the scanning signal output from the gate line driver circuit 603 to the pixel 605. The scanning signal supplied to the gate line GL_{EL}[j] is a signal for writing gradation voltage supplied to the signal line SL_{EL}[k] into the pixel.

The signal line driver circuit 604 has a function of transmitting a gradation voltage for driving a liquid crystal element included in the pixel 605 to the signal line SL_{LC}[k]. Furthermore, the signal line driver circuit 604 has a function of transmitting a gradation voltage for driving a light-emitting element included in the pixel 605 to the signal line SL_{EL}[k]. The signal line SL_{LC}[k] transmits the scanning signal output from the gate line driver circuit 603 to the pixel 605. The scanning signal to be applied to the gate line GL_{EL}[j] is a signal for writing the gradation voltage supplied to the signal line SL_{EL}[k] to the pixel.

Various signals (a clock signal, a start pulse, and a gradation voltage) that are necessary for driving are input to the gate line driver circuit 602, the gate line driver circuit 603, and the signal line driver circuit 604. As described above, the signal line driver circuit 604 of one embodiment of the present invention has a function of generating gradation data to be applied to two display elements of a liquid crystal element and a light-emitting element from one gradation data, in accordance with the surrounding environment of the display device and supplying the gradation data to a pixel including the two display elements. Thus, the amount of gradation data supplied to the signal line driver circuit 604 can be reduced, low power consumption can be achieved by the reduction in the transfer rate of the gradation data, and the reduction in the circuit area can be achieved by the reduction in the size of the interface.

Next, the pixel 605 is described. FIG. 9B illustrates an example of a circuit diagram of the pixel 605. FIG. 9B illustrates transistors M1 to M3, a liquid crystal element LC, a capacitor C_{SLC}, and a light-emitting element EL. As illustrated in FIG. 9B, the elements in the pixel 605 is connected to the gate line GL_{LC}[j], the gate line GL_{EL}[j], the signal line SL_{LC}[k], the signal line SL_{EL}[k], a capacitor line L_{CS}, a current supply line Lₐₙₒ, and a common potential line L_{cas}.

The conduction state of the transistor M1 is controlled, whereby a gradation voltage for driving the liquid crystal element LC is applied to the capacitor C_{SLC}. The conduction state of the transistor M2 is controlled, whereby a gradation voltage for driving the light-emitting element EL is applied to a gate of the transistor M3. Current is supplied between the current supply line Lₐₙₒ and the common potential line L_{cas} in accordance with the voltage of the gate of the transistor M3, whereby the light-emitting element EL is driven.

As the transistors M1 to M3, n-channel transistors can be used. The n-channel transistors can be replaced with p-channel transistors by changing the magnitude relationship among voltages of the wirings. Silicon can be used as semiconductor materials of the transistors M1 to M3. As silicon, single crystal silicon, polysilicon, microcrystalline silicon, amorphous silicon, or the like can be used as appropriate.

Alternatively, an oxide semiconductor can be used as the semiconductor materials of the transistors M1 to M3. Specifically, an oxide semiconductor containing indium or an oxide semiconductor containing indium, gallium, and zinc can be used for the oxide semiconductor.

For the transistors M1 to M3 included in the pixel 605, various types of transistors, for example, a bottom gate transistor, a top gate transistor, and the like can be used.

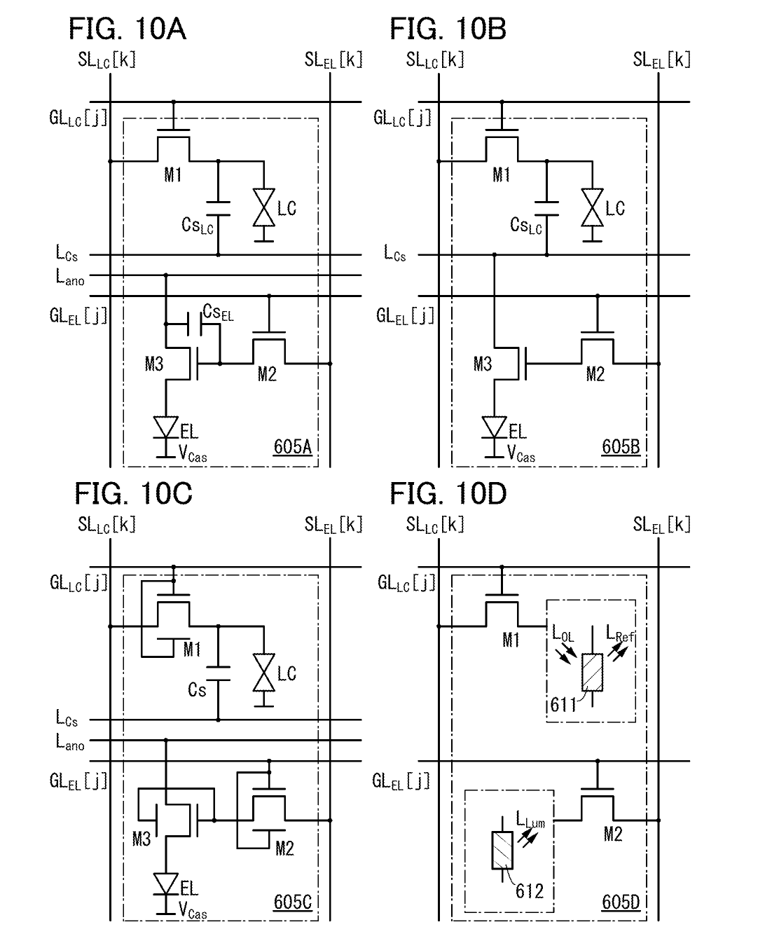

The pixel 605 may include a capacitor C_{SEL} so that the gradation voltage for driving the light-emitting element EL is held in the gate of the transistor M3. For example, as shown in the circuit structure of a pixel 605A in FIG. 10A, the capacitor C_{SEL} can be provided between the gate of the transistor M3 and the current supply line Lₐₙₒ. With such a structure, the gradation voltage for driving the light-emitting element EL can be properly held.

The wirings connected to the pixel 605 may be shared, so that the number of wirings can be reduced. For example, as shown in the circuit structure of a pixel 605B in FIG. 10B, one wiring may serve as both the capacitor line L_{CS} and the current supply line Lₐₙₒ, and the current supply line Lₐₙₒ may be eliminated. With such a structure, the pixel size can be reduced or the aperture ratio can be improved.

The transistors M1 to M3 included in the pixel 605 may be transistors having back gates. For example, as shown in the circuit structure of a pixel 605C in FIG. 10C, each of the transistors M1 to M3 may have a back gate. Voltages to be applied to the back gates may be supplied from a wiring that is different from the gate line GL_{LC}[j] and the gate line GL_{EL}[j]. Only one transistor, for example, the transistor M3 may have a back gate. With such a structure, the threshold voltage of the transistor can be controlled, or the amount of current flowing through the transistor can be increased.

The liquid crystal element LC and the light-emitting element EL included in the pixel 605 may be replaced with each other. For example, as shown in the circuit structure of a pixel 605D in FIG. 10D, as the liquid crystal element LC, a display element 611 in which the amount reflected light L_{REF} obtained by reflection of external light L_{OL} is adjusted to be used for display can be used. Furthermore, as the light-emitting element EL, a display element 612 in which self-luminous light L_{Lum} is adjusted to be used for display can be used. Note that the number of transistors in the pixel 605D can be changed as appropriate in accordance with the kinds of the display elements 611 and 612 and the function of the pixel 605D.

Note that as the display element 611, for example, a combined structure of a polarizing plate and a liquid crystal element or a MEMS shutter display element can be used. The display element utilizing external light reflection can reduce power consumption of the display device.

Specifically, the liquid crystal element can be driven by any of the following driving methods: an in-plane-switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like. In addition, the liquid crystal element can be driven by, for example, a vertical alignment (VA) mode such as a multi-domain vertical alignment (MVA) mode, a patterned vertical alignment (PVA) mode, an electrically controlled birefringence (ECB) mode, a continuous pinwheel alignment (CPA) mode, or an advanced super view (ASV) mode.

For the liquid crystal element, a liquid crystal material such as thermotropic liquid crystal, low-molecular liquid crystal, high-molecular liquid crystal, polymer dispersed liquid crystal, ferroelectric liquid crystal, or anti-ferroelectric liquid crystal can be used. Alternatively, a liquid crystal material which exhibits a cholesteric phase, a smectic phase, a cubic phase, a chiral nematic phase, an isotropic phase, or the like can be used. Alternatively, a liquid crystal material which exhibits a blue phase can be used.

An EL element such as an organic electroluminescence element or an inorganic electroluminescence element, a light-emitting diode, or the like can be used for the display element 612.

A stack formed to emit white light can be used as the EL element. Specifically, a stack of a layer containing a light-emitting organic compound containing a fluorescent material that emits blue light, a layer containing a material that is other than a fluorescent material and that emits green light and/or red light, or a layer containing a material that is other than a fluorescent material and that emits yellow light can be used.

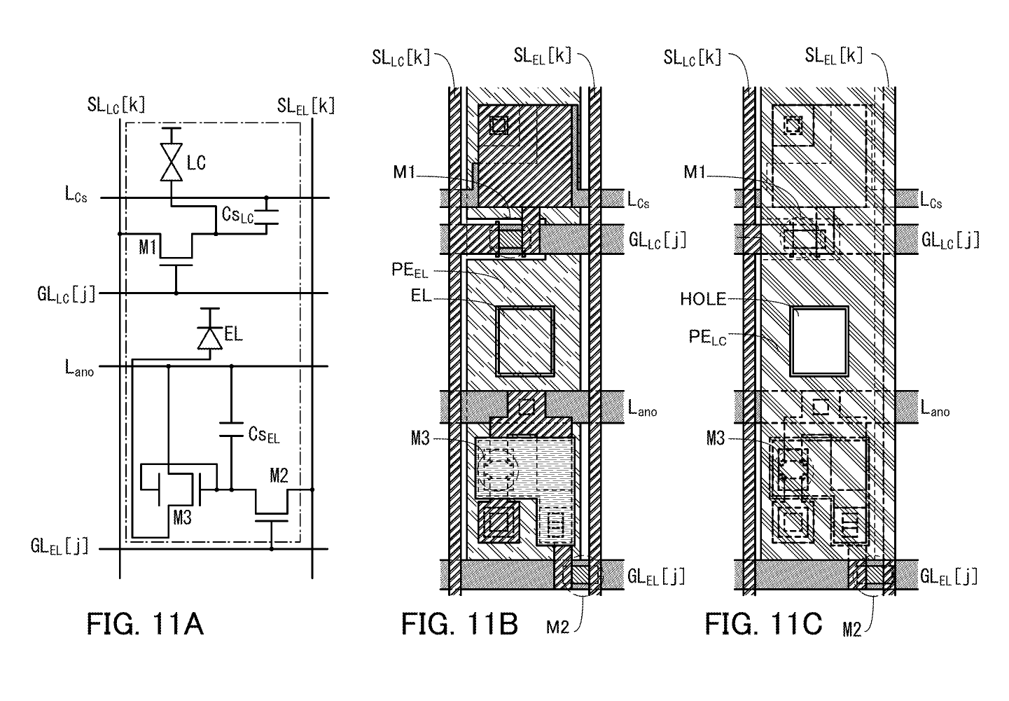

Next, a layout diagram applicable to the pixel 605 is described. In the circuit diagram in FIG. 11A, the transistor M3 in FIG. 10A is changed to a transistor having a back gate. The layout diagram in FIG. 11B corresponds to the circuit diagram in FIG. 11A, which shows an electrode PE_{EL} of the light-emitting element EL, the light-emitting element EL, arrangement of the transistor M1 to M3, the gate line GL_{LC}[j], the gate line GL_{EL}[j], the signal line SL_{LC}[k], the signal line SL_{EL} [k], the capacitor line L_{CS}, the current supply line Lₐₙₒ, and the common potential line L_{cas}. The layout diagram in FIG. 11C corresponds to the circuit diagram in FIG. 11A, which shows a reflective electrode PE_{LC} of the liquid crystal element LC, an opening HOLE arranged so as to overlap with the light-emitting element EL, arrangement of the transistors M1 to M3, the gate line GL_{LC}[j], the gate line GL_{EL}[j], the signal line SL_{LC}[k], the signal line SL_{EL}[k], the capacitor line L_{CS}, the current supply line Lₐₙₒ, and the common potential line L_{cas}. Note that the reflective electrode PE_{LC} is also simply referred to as an electrode in some cases.

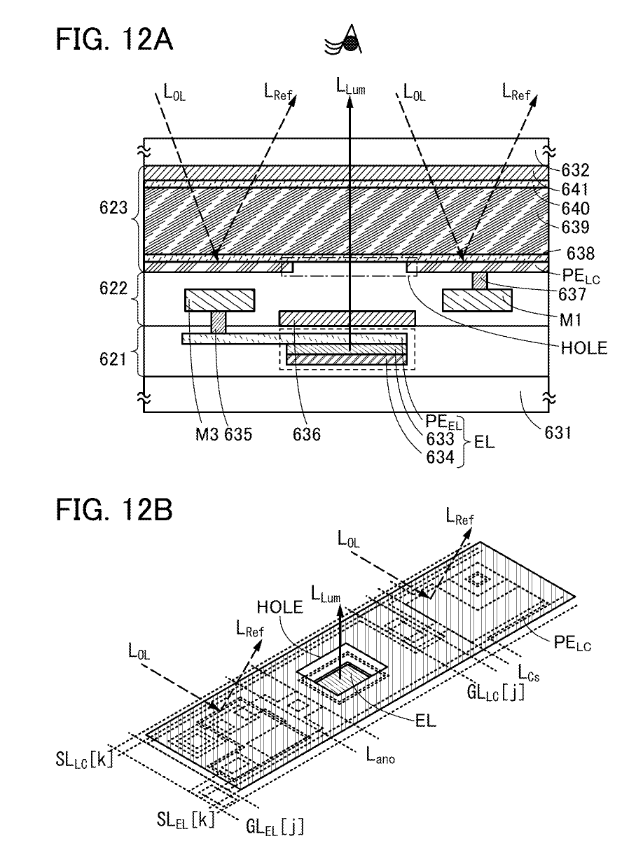

Though the liquid crystal element LC and the light-emitting element EL are provided separately in the layout diagrams in FIGS. 11B and 11C, they are provided to overlap with each other. FIG. 12A is a schematic cross-sectional view illustrating a stacked structure of the liquid crystal element LC and the light-emitting element EL. In FIG. 12A, a layer 621 including the light-emitting element EL, a layer 622 including the transistor, and a layer 623 including the liquid crystal element LC are shown. The layers 621 to 623 are provided between substrates 631 and 632. Though not shown in the figure, an optical member such as a polarizing plate may be included.

The layer 621 includes the light-emitting element EL. The light-emitting element EL includes the electrode PE_{EL}, a light-emitting layer 633, an electrode 634 that are shown in FIG. 11B. When current flows to the light-emitting element 633 between the electrode PE_{EL} and the electrode 634, light L_{Lum} is emitted. The intensity of the light L_{Lum} is controlled by the transistor M3 in the layer 622.

The layer 622 includes the transistors M1 and M3, and a color filter 636. The layer 622 further includes a conductive layer 637 for connecting the transistor M1 and the reflective electrode PE_{LC}, and an electrode 635 for connecting the transistor M3 and the electrode PE_{EL}. The color filter 636 is provided when the light L_{Lum} is white, and light with a specific wavelength can be emitted to the viewer side. The color filter 636 is provided so as to overlap with the opening HOLE. The transistor M1 to M3 (the transistor M2 is not shown) are provided so as to overlap with the reflective electrode PE_{LC}.

The layer 623 includes the opening HOLE, the reflective electrode PE_{LC}, a conductive layer 638, a liquid crystal 639, a conductive layer 640, and a color filter 641. Orientation of the liquid crystal 639 between a pair of the conductive layer 638 and the conductive layer 640 is controlled by the conductive layer 638. The reflective electrode PE_{LC} reflects the external light L_{OL} and emits the reflected light L_{REF}. The intensity of the reflected light L_{REF} is controlled by adjustment of orientation of the liquid crystal 639 by the transistor M1. The opening HOLE is provided in a position that transmits the light L_{Lum} emitted from the light-emitting element EL in the layer 621.

A material that reflects visible light can be used for the reflective electrode PE_{LC}, for example. Specifically, a material containing silver can be used for the reflective film. For example, a material containing silver, palladium, and the like or a material containing silver, copper, and the like can be used for the reflective film. Alternatively, for example, a material with unevenness on its surface can be used for the reflective film. In that case, incident light can be reflected in various directions so that a white image can be displayed.

A material that transmits visible light can be used for the conductive layers 638 and 640. Specifically, a conductive oxide such as indium oxide, indium tin oxide, indium zinc oxide, zinc oxide, or zinc oxide to which gallium is added, or graphene can be used.

For example, an inorganic material such as glass, ceramics, or a metal can be used for the substrates 631 and 632. Alternatively, a flexible material, for example, an organic material such as a resin film or plastics can be used for the substrates 631 and 632. Alternatively, an appropriate stack of members such as a polarizing plate, a retardation plate, and a prism sheet can be used for the substrates 631 and 632.

For example, an insulating inorganic material, an insulating organic material, or an insulating composite material containing an inorganic material and an organic material can be used for the insulating layer included in the display device. For example, for the insulating layer, a silicon oxide film, a silicon nitride film, a silicon oxynitride film, an aluminum oxide film, or a stacked material of any of these films can be used. Alternatively, polyester, polyolefin, polyamide, polyimide, polycarbonate, polysiloxane, an acrylic resin, or a stacked material or a composite material of a plurality of resins selected from these materials can be used.

The conductive layers such as the electrodes 635 and 637 included in the display device are formed using a conductive material and can be used for wirings or the like. For example, a metal element selected from aluminum, gold, platinum, silver, copper, chromium, tantalum, titanium, molybdenum, tungsten, nickel, iron, cobalt, palladium, and manganese can be used. Alternatively, an alloy including any of the above-described metal elements, or the like can be used for the wiring or the like.

FIG. 12B is a perspective view in which the layout diagrams in FIGS. 11B and 11C overlap with each other for illustrating the stacked structure of the liquid crystal element LC and the light-emitting element EL. As illustrated in FIG. 12B, the liquid crystal element LC and the light-emitting element EL are provided to overlap with each other. Then, the opening HOLE is provided in a position that transmits the light L_{Lum} emitted from the light-emitting element EL. With such a structure, switching of display elements in accordance with luminance of the surrounding environment can be realized without increasing the area occupied by the pixel. Consequently, a display device with improved visibility can be obtained.

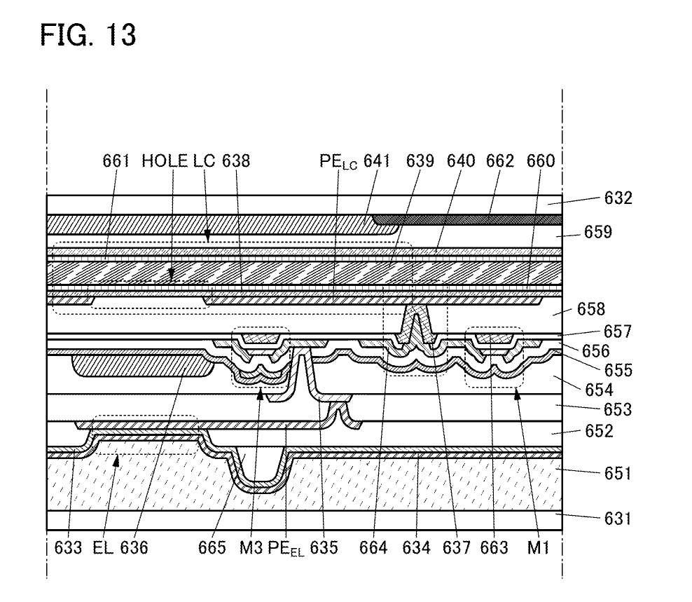

FIG. 13 shows a detailed schematic cross-sectional view of the pixel in FIG. 12A. In FIG. 13, the same components as in FIG. 12A are denoted by the same reference numerals and the description thereof is not repeated.

In the schematic cross-sectional view of the pixel of the display device in FIG. 13, in addition to the components in FIG. 12A, an adhesive layer 651, an insulating layer 652, an insulating layer 653, an insulating layer 654, an insulating layer 655, an insulating layer 656, an insulating layer 657, an insulating layer 658, an insulating layer 659, an alignment film 660, an alignment film 661, a light-shielding film 662, a conductive layer 663, a conductive layer 664, and an insulating layer 665 are included between the substrates 631 and 632

The insulating layer 652, the insulating layer 653, the insulating layer 654, the insulating layer 655, the insulating layer 656, the insulating layer 657, the insulating layer 658, the insulating layer 659, and the insulating layer 665 can be formed using an insulating inorganic material, an insulating organic material, or an insulating composite material containing an inorganic material and an organic material. For example, for the insulating layer, a silicon oxide film, a silicon nitride film, a silicon oxynitride film, an aluminum oxide film, or a stacked material of any of these films can be used. Alternatively, polyester, polyolefin, polyamide, polyimide, polycarbonate, polysiloxane, an acrylic resin, or a stacked material or a composite material of a plurality of kinds of resins selected from these materials can be used.

For the conductive layers 663 and 664, a conductive material can be used for the wiring. For example, a metal element selected from aluminum, gold, platinum, silver, copper, chromium, tantalum, titanium, molybdenum, tungsten, nickel, iron, cobalt, palladium, and manganese can be used for the conductive layer. Alternatively, an alloy including any of the above-described metal elements, or the like can be used for the wiring or the like.

Any of a variety of curable adhesives, e.g., light curable adhesives such as a UV curable adhesive, a reactive curable adhesive, a thermal curable adhesive, and an anaerobic adhesive can be used for the adhesive layer 651. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, and the like. In particular, a material with low moisture permeability, such as an epoxy resin, is preferred. Alternatively, a two-component type resin may be used. Still alternatively, an adhesive sheet or the like may be used.

For the alignment film 660 and the alignment film 661, an organic resin such as polyimide can be used. In the case where optical alignment treatment for aligning the liquid crystal 639 in a predetermined direction is performed, the alignment film 660 and the alignment film 661 may be omitted. Also in the case of using a liquid crystal which does not need alignment treatment, the alignment film 660 and the alignment film 661 may be omitted.

The light-blocking film 662 can be formed using a light-blocking material which absorbs light, such as chromium, chromium oxide, or a block resin.

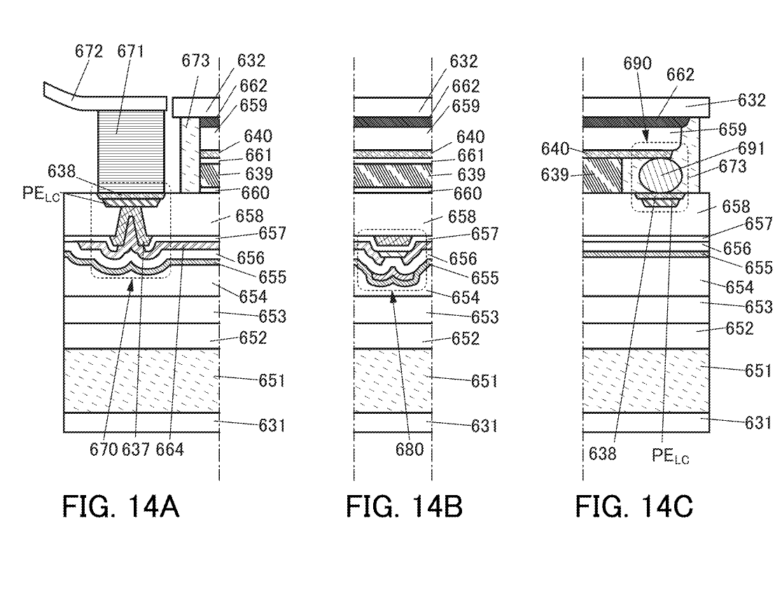

FIGS. 14A to 14C show schematic cross-sectional views of a terminal portion, a driver circuit portion, and a common contact portion which correspond to the schematic cross-sectional view of the pixel of the display device in FIG. 13. In FIGS. 14A to 14C, the same components as in FIG. 12A and FIG. 13 are denoted by the same reference numerals and the description thereof is not repeated.

FIG. 14A is the schematic cross-sectional view of the terminal portion of the display device. In a connection portion 670 for connection to an external circuit in the terminal portion, the conductive layer 637, the conductive layer 664, the reflective electrode PE_{LC}, and the conductive layer 638 are stacked. A flexible printed circuit (FPC) 672 is connected to the connection portion 670 through a connection layer 671. An adhesive layer 673 is provided at an end portion of the substrate 632, thereby attaching the substrate 632 and the substrate 631 to each other.

FIG. 14B is the schematic cross-sectional view of the driver circuit portion of the display device. A transistor 680 can have the same structure as the transistor M3.

FIG. 14C is the schematic cross-sectional view of the common contact portion of the display device. At a connection portion 690 in the common contact portion, the conductive layer 640 on the substrate 632 side is connected to the conductive layer 638 and the reflective electrode PE_{LC} on the substrate 631 side through a connector 691 in the adhesive layer 673.

The above is the description of the components of the display device.

### SUMMARY

In the above semiconductor device, gradation data to be applied to different display elements can be generated inside the device for driving a display device including the display elements. The generated gradation data given to different display elements are configured to differ in accordance with the designed luminance based on gradation data to be displayed and the intensity of reflected light based on illuminance data. Because the amount of data to be supplied from the exterior to the driver circuit can be reduced, low power consumption due to a reduction in the data transfer rate, and a reduction in the circuit area due to a reduction in the size of an interface can be achieved.

In a pixel of the pixel portion to which a gradation voltage is supplied based on gradation data, display can be performed by combining a liquid crystal element and a light-emitting element and changing gradation data in accordance with luminance of the surrounding environment. The display device having such a pixel can have excellent visibility in a bright place such as a place exposed to direct sunlight, in a dark place such as a place under the moonlight, in a dim place such as in a room, or in a slightly bright place such as in a shade in the outdoors.

### Embodiment 2

In this embodiment, an example of a transistor that can be used as the transistors described in the above embodiment will be described with reference to drawings.

The display device of one embodiment of the present invention can be fabricated by using a transistor with any of various modes, such as a bottom-gate transistor or a top-gate transistor. Therefore, a material for a semiconductor layer or the structure of a transistor can be easily changed depending on the existing production line.

### [Bottom-Gate Transistor]

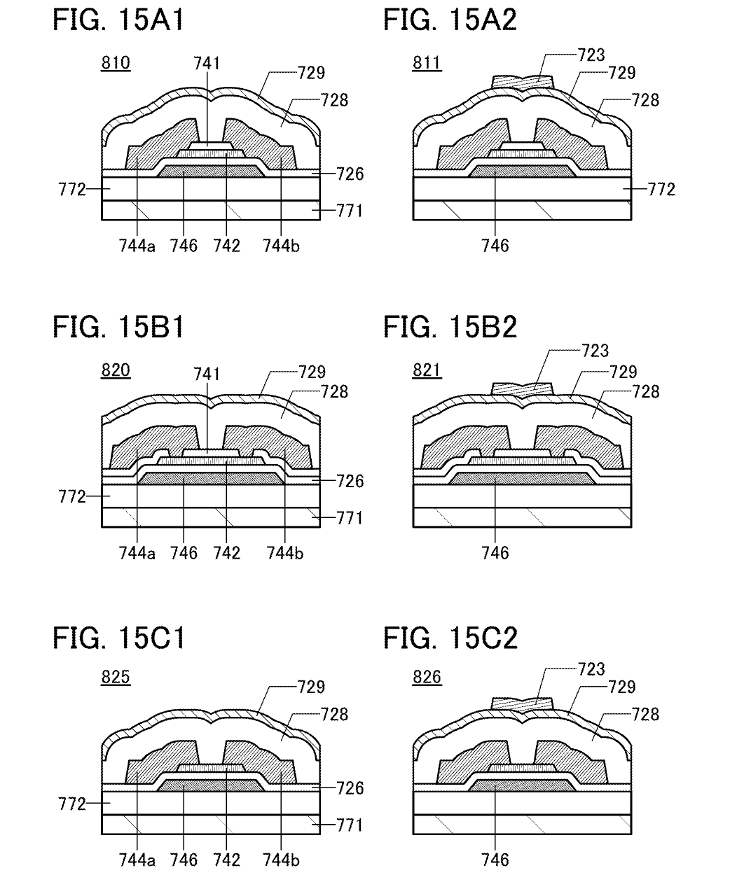

FIG. 15A1 is a cross-sectional view of a transistor 810 that is a channel-protective transistor, which is a type of bottom-gate transistor. In FIG. 15A1, the transistor 810 is formed over a substrate 771. The transistor 810 includes an electrode 746 over the substrate 771 with an insulating layer 772 provided therebetween. The transistor 810 includes a semiconductor layer 742 over the electrode 746 with an insulating layer 726 provided therebetween. The electrode 746 can serve as a gate electrode. The insulating layer 726 can serve as a gate insulating layer.

The transistor 810 includes an insulating layer 741 over a channel formation region in the semiconductor layer 742. The transistor 810 includes an electrode 744a and an electrode 744b which are partly in contact with the semiconductor layer 742 and over the insulating layer 726. The electrode 744a can serve as one of a source electrode and a drain electrode. The electrode 744b can serve as the other of the source electrode and the drain electrode. Part of the electrode 744a and part of the electrode 744b are formed over the insulating layer 741.

The insulating layer 741 can serve a channel protective layer. With the insulating layer 741 provided over the channel formation region, the semiconductor layer 742 can be prevented from being exposed at the time of forming the electrodes 744a and 744b. Thus, the channel formation region in the semiconductor layer 742 can be prevented from being etched at the time of forming the electrodes 744a and 744b. According to one embodiment of the present invention, a transistor with favorable electrical characteristics can be provided.

The transistor 810 includes an insulating layer 728 over the electrode 744a, the electrode 744b, and the insulating layer 741 and further includes an insulating layer 729 over the insulating layer 728.

The insulating layer 772 can be formed using a material and a method similar to those of insulating layers 722 and 705. Note that the insulating layer 772 may be formed of a stack of insulating layers. For example, the semiconductor layer 742 can be formed using a material and a method similar to those of the semiconductor layer 708. Note that the semiconductor layer 742 may be formed of a stack of semiconductor layers. For example, the electrode 746 can be formed using a material and a method similar to those of the electrode 706. Note that the electrode 746 may be formed of a stack of conductive layers. The insulating layer 726 can be formed using a material and a method similar to those of the insulating layer 707. Note that the insulating layer 726 may be formed of a stack of insulating layers. For example, the electrodes 744a and 744b can be formed using a material and a method similar to those of the electrode 714 or 715. Note that the electrodes 744a and 744b may be formed of a stack of conductive layers. For example, the insulating layer 741 can be formed using a material and a method similar to those of the insulating layer 726. Note that the insulating layer 741 may be formed of a stack of insulating layers. For example, the insulating layer 728 can be formed using a material and a method similar to those of the insulating layer 710. Note that the insulating layer 728 may be formed of a stack of insulating layers. For example, the insulating layer 729 can be formed using a material and a method similar to those of the insulating layer 711. Note that the insulating layer 729 may be formed of a stack of insulating layers.

The electrode, the semiconductor layer, the insulating layer, and the like used in the transistor disclosed in this embodiment can be formed using a material and a method disclosed in any of the other embodiments.

In the case where an oxide semiconductor is used for the semiconductor layer 742, a material capable of removing oxygen from part of the semiconductor layer 742 to generate oxygen vacancies is preferably used for regions of the electrodes 744a and 744b that are in contact with at least the semiconductor layer 742. The carrier concentration in the regions of the semiconductor layer 742 where oxygen vacancies are generated is increased, so that the regions become n-type regions (n⁺ layers). Accordingly, the regions can serve as a source region and a drain region. When an oxide semiconductor is used for the semiconductor layer 742, examples of the material capable of removing oxygen from the semiconductor layer 742 to generate oxygen vacancies include tungsten and titanium.

Formation of the source region and the drain region in the semiconductor layer 742 makes it possible to reduce the contact resistance between the semiconductor layer 742 and each of the electrodes 744a and 744b. Accordingly, the electric characteristics of the transistor, such as the field-effect mobility and the threshold voltage, can be favorable.

In the case where a semiconductor such as silicon is used for the semiconductor layer 742, a layer that serves as an n-type semiconductor or a p-type semiconductor is preferably provided between the semiconductor layer 742 and the electrode 744a and between the semiconductor layer 742 and the electrode 744b. The layer that serves as an n-type semiconductor or a p-type semiconductor can serve as the source region or the drain region in the transistor.

The insulating layer 729 is preferably formed using a material that can prevent or reduce diffusion of impurities into the transistor from the outside. The insulating layer 729 is not necessarily formed.

When an oxide semiconductor is used for the semiconductor layer 742, heat treatment may be performed before and/or after the insulating layer 729 is formed. The heat treatment can fill oxygen vacancies in the semiconductor layer 742 by diffusing oxygen contained in the insulating layer 729 or other insulating layers into the semiconductor layer 742. Alternatively, the insulating layer 729 may be formed while the heat treatment is performed, so that oxygen vacancies in the semiconductor layer 742 can be filled.

Note that a CVD method can be generally classified into a plasma enhanced CVD (PECVD) method using plasma, a thermal CVD (TCVD) method using heat, and the like. A CVD method can be further classified into a metal CVD (MCVD) method, a metal organic CVD (MOCVD) method, and the like according to a source gas to be used.

Furthermore, an evaporation method can be generally classified into a resistance heating evaporation method, an electron beam evaporation method, a molecular beam epitaxy (MBE) method, a pulsed laser deposition (PLD) method, an ion beam assisted deposition (IBAD) method, an atomic layer deposition (ALD) method, and the like.

By using the PECVD method, a high-quality film can be formed at a relatively low temperature. By using a deposition method that does not use plasma for deposition, such as an MOCVD method or an evaporation method, a film with few defects can be formed because damage is not easily caused on a surface on which the film is deposited.

A sputtering method is generally classified into a DC sputtering method, a magnetron sputtering method, an RF sputtering method, an ion beam sputtering method, an electron cyclotron resonance (ECR) sputtering method, a facing-target sputtering method, and the like.

In the facing-target sputtering method, plasma is confined between targets; thus, plasma damage to a substrate can be reduced. Furthermore, step coverage can be improved because the incident angle of a sputtered particle to a substrate can be made smaller depending on the inclination of the target.

A transistor 811 illustrated in FIG. 15A2 is different from the transistor 810 in that an electrode 723 that can serve as a back gate electrode is provided over the insulating layer 729. The electrode 723 can be formed using a material and a method similar to those of the electrode 746.

In general, the back gate electrode is formed using a conductive layer and positioned so that a channel formation region of a semiconductor layer is positioned between the gate electrode and the back gate electrode. Thus, the back gate electrode can function in a manner similar to that of the gate electrode. The potential of the back gate electrode may be the same as that of the gate electrode or may be a ground (GND) potential or a predetermined potential. By changing the potential of the back gate electrode independently of the potential of the gate electrode, the threshold voltage of the transistor can be changed.

The electrode 746 and the electrode 723 can each serve as a gate electrode. Thus, the insulating layers 726, 728, and 729 can each serve as a gate insulating layer. The electrode 723 may also be provided between the insulating layers 728 and 729.

In the case where one of the electrodes 746 and 723 is referred to as a “gate electrode”, the other is referred to as a “back gate electrode”. For example, in the transistor 811, in the case where the electrode 723 is referred to as a “gate electrode”, the electrode 746 is referred to as a “back gate electrode”. In the case where the electrode 723 is used as a “gate electrode”, the transistor 811 can be regarded as a kind of top-gate transistor. Alternatively, one of the electrodes 746 and 723 may be referred to as a “first gate electrode”, and the other may be referred to as a “second gate electrode”.

By providing the electrodes 746 and 723 with the semiconductor layer 742 provided therebetween and setting the potentials of the electrodes 746 and 723 to be the same, a region of the semiconductor layer 742 through which carriers flow is enlarged in the film thickness direction; thus, the number of transferred carriers is increased. As a result, the on-state current and field-effect mobility of the transistor 811 are increased.

Therefore, the transistor 811 has a high on-state current for its area. That is, the area of the transistor 811 can be small for a required on-state current. According to one embodiment of the present invention, the area occupied by a transistor can be reduced. Therefore, according to one embodiment of the present invention, a semiconductor device having a high degree of integration can be provided.

The gate electrode and the back gate electrode are formed using conductive layers and thus each have a function of preventing an electric field generated outside the transistor from influencing the semiconductor layer in which the channel is formed (in particular, an electric field blocking function against static electricity and the like). When the back gate electrode is formed larger than the semiconductor layer such that the semiconductor layer is covered with the back gate electrode, the electric field blocking function can be enhanced.

Since the electrodes 746 and 723 each have a function of blocking an electric field generated outside, electric charge of charged particles and the like generated on the insulating layer 772 side or above the electrode 723 do not influence the channel formation region in the semiconductor layer 742. Thus, degradation by a stress test (e.g., a negative gate bias temperature (−GBT) stress test in which negative electric charge is applied to a gate) can be reduced. Furthermore, a change in gate voltage (rising voltage) at which on-state current starts flowing depending on drain voltage can be reduced. Note that this effect is obtained when the electrodes 746 and 723 have the same potential or different potentials.

The BT stress test is one kind of acceleration test and can evaluate, in a short time, a change by long-term use (i.e., a change over time) in characteristics of a transistor. In particular, the amount of change in the threshold voltage of a transistor before and after the BT stress test is an important indicator when examining the reliability of the transistor. As the change in threshold voltage is smaller, the transistor has higher reliability.

By providing the electrodes 746 and 723 and setting the potentials of the electrodes 746 and 723 to be the same, the amount of change in threshold voltage is reduced. Accordingly, variations in electrical characteristics among a plurality of transistors are also reduced.

A transistor including a back gate electrode has a smaller change in threshold voltage before and after a positive GBT stress test, in which positive electric charge is applied to a gate, than a transistor including no back gate electrode.

When the back gate electrode is formed using a light-blocking conductive film, light can be prevented from entering the semiconductor layer from the back gate electrode side. Therefore, photodegradation of the semiconductor layer can be prevented, and deterioration in electrical characteristics of the transistor, such as a shift of the threshold voltage, can be prevented.

According to one embodiment of the present invention, a transistor with high reliability can be provided. Moreover, a semiconductor device with high reliability can be provided.

FIG. 15B1 is a cross-sectional view of a channel-protective transistor 820 that is a type of bottom-gate transistor. The transistor 820 has substantially the same structure as the transistor 810 but is different from the transistor 810 in that the insulating layer 741 covers an end portion of the semiconductor layer 742. The semiconductor layer 742 is electrically connected to the electrode 744a through an opening formed by selectively removing part of the insulating layer 741 which overlaps with the semiconductor layer 742. The semiconductor layer 742 is electrically connected to the electrode 744b through another opening formed by selectively removing part of the insulating layer 741 which overlaps with the semiconductor layer 742. A region of the insulating layer 741 which overlaps with the channel formation region can serve as a channel protective layer.

A transistor 821 illustrated in FIG. 15B2 is different from the transistor 820 in that the electrode 723 that can serve as a back gate electrode is provided over the insulating layer 729.

With the insulating layer 741, the semiconductor layer 742 can be prevented from being exposed at the time of forming the electrodes 744a and 744b. Thus, the semiconductor layer 742 can be prevented from being reduced in thickness at the time of forming the electrodes 744a and 744b.

The length between the electrode 744a and the electrode 746 and the length between the electrode 744b and the electrode 746 in the transistors 820 and 821 are larger than those in the transistors 810 and 811. Thus, the parasitic capacitance generated between the electrode 744a and the electrode 746 can be reduced. Moreover, the parasitic capacitance generated between the electrode 744b and the electrode 746 can be reduced. According to one embodiment of the present invention, a transistor with favorable electrical characteristics can be provided.

A transistor 825 illustrated in FIG. 15C1 is a channel-etched transistor that is a type of bottom-gate transistor. In the transistor 825, the electrodes 744a and 744b are formed without providing the insulating layer 741. Thus, part of the semiconductor layer 742 that is exposed at the time of forming the electrodes 744a and 744b is etched in some cases. However, since the insulating layer 741 is not provided, the productivity of the transistor can be increased.

A transistor 826 illustrated in FIG. 15C2 is different from the transistor 825 in that the electrode 723 that can function as a back gate electrode is provided over the insulating layer 729.

### [Top-Gate Transistor]

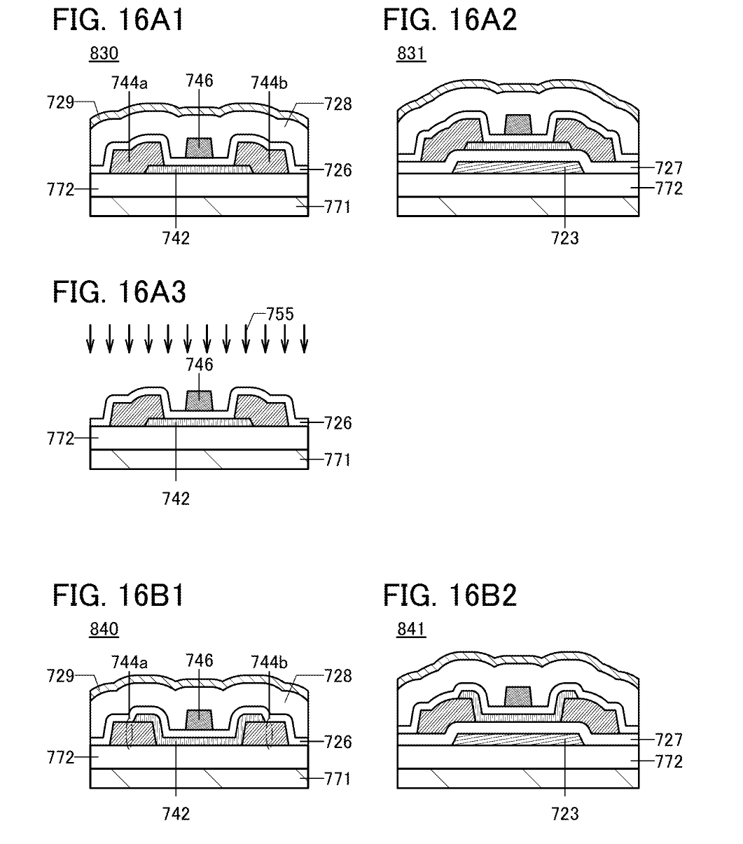

FIG. 16A1 is a cross-sectional view of a transistor 830 that is a type of top-gate transistor. The transistor 830 includes the semiconductor layer 742 over the insulating layer 772, the electrodes 744a and 744b that are over the semiconductor layer 742 and the insulating layer 772 and in contact with part of the semiconductor layer 742, the insulating layer 726 over the semiconductor layer 742 and the electrodes 744a and 744b, and the electrode 746 over the insulating layer 726.

Since the electrode 746 overlaps with neither the electrode 744a nor the electrode 744b in the transistor 830, the parasitic capacitance generated between the electrodes 746 and 744a and the parasitic capacitance generated between the electrodes 746 and 744b can be reduced. After the formation of the electrode 746, an impurity 755 is introduced into the semiconductor layer 742 using the electrode 746 as a mask, so that an impurity region can be formed in the semiconductor layer 742 in a self-aligned manner (see FIG. 16A3). According to one embodiment of the present invention, a transistor with favorable electrical characteristics can be provided.

The introduction of the impurity 755 can be performed with an ion implantation apparatus, an ion doping apparatus, or a plasma treatment apparatus.

As the impurity 755, for example, at least one kind of element of Group 13 elements and Group 15 elements can be used. In the case where an oxide semiconductor is used for the semiconductor layer 742, it is possible to use at least one kind of element of a rare gas, hydrogen, and nitrogen as the impurity 755.

A transistor 831 illustrated in FIG. 16A2 is different from the transistor 830 in that the electrode 723 and the insulating layer 727 are included. The transistor 831 includes the electrode 723 formed over the insulating layer 772 and the insulating layer 727 formed over the electrode 723. The electrode 723 can serve as a back gate electrode. Thus, the insulating layer 727 can serve as a gate insulating layer. The insulating layer 727 can be formed using a material and a method similar to those of the insulating layer 726.

Like the transistor 811, the transistor 831 has a high on-state current for its area. That is, the area of the transistor 831 can be small for a required on-state current. According to one embodiment of the present invention, the area occupied by a transistor can be reduced. Therefore, according to one embodiment of the present invention, a semiconductor device having a high degree of integration can be provided.

A transistor 840 illustrated in FIG. 16B1 is a type of top-gate transistor. The transistor 840 is different from the transistor 830 in that the semiconductor layer 742 is formed after the formation of the electrodes 744a and 744b. A transistor 841 illustrated in FIG. 16B2 is different from the transistor 840 in that the electrode 723 and the insulating layer 727 are included. In the transistors 840 and 841, part of the semiconductor layer 742 is formed over the electrode 744a and another part of the semiconductor layer 742 is formed over the electrode 744b.

Like the transistor 811, the transistor 841 has a high on-state current for its area. That is, the area of the transistor 841 can be small for a required on-state current. According to one embodiment of the present invention, the area occupied by a transistor can be reduced. Therefore, according to one embodiment of the present invention, a semiconductor device having a high degree of integration can be provided.

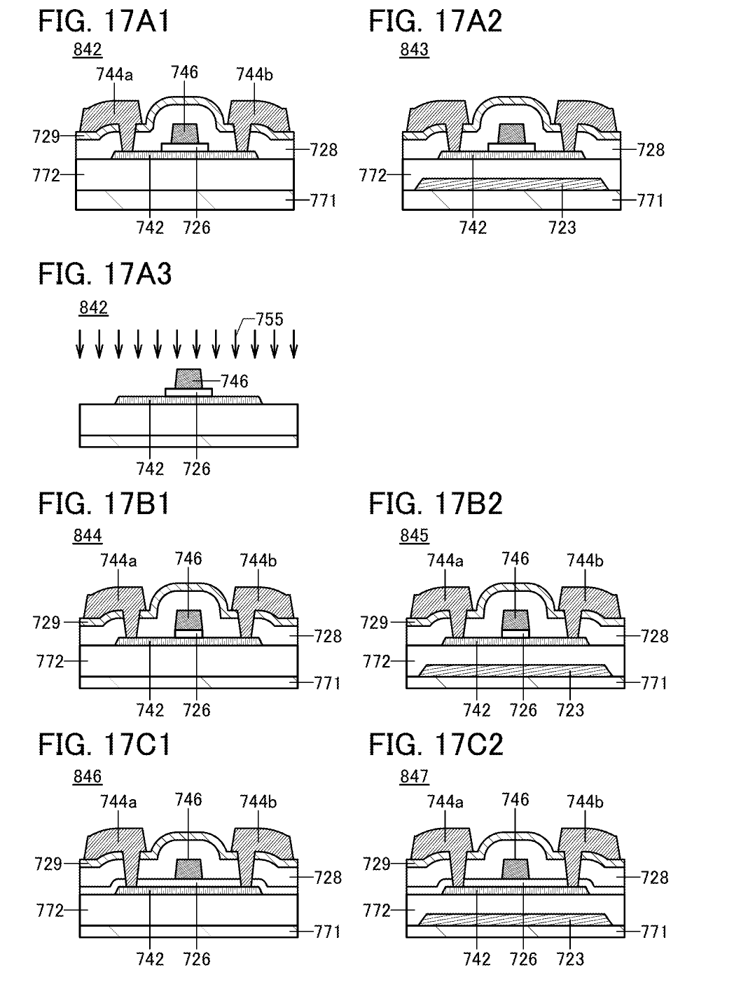

A transistor 842 illustrated in FIG. 17A1 is a type of top-gate transistor. The transistor 842 is different from the transistor 830 or 840 in that the electrodes 744a and 744b are formed after the formation of the insulating layer 729. The electrodes 744a and 744b are electrically connected to the semiconductor layer 742 through openings formed in the insulating layers 728 and 729.

Part of the insulating layer 726 that does not overlap with the electrode 746 is removed, and the impurity 755 is introduced into the semiconductor layer 742 using the electrode 746 and the insulating layer 726 that is left as a mask, so that an impurity region can be formed in the semiconductor layer 742 in a self-aligned manner (see FIG. 17A3). The transistor 842 includes a region where the insulating layer 726 extends beyond an end portion of the electrode 746. The semiconductor layer 742 in a region into which the impurity 755 is introduced through the insulating layer 726 has a lower impurity concentration than the semiconductor layer 742 in a region into which the impurity 755 is introduced without through the insulating layer 726. Thus, a lightly doped drain (LDD) region is formed in a region of the semiconductor layer 742, which is adjacent to a portion which overlaps with the electrode 746.

A transistor 843 illustrated in FIG. 17A2 is different from the transistor 842 in that the electrode 723 is included. The transistor 843 includes the electrode 723 that is formed over the substrate 771 and overlaps with the semiconductor layer 742 with the insulating layer 772 provided therebetween. The electrode 723 can serve as a back gate electrode.

As in a transistor 844 illustrated in FIG. 17B1 and a transistor 845 illustrated in FIG. 17B2, the insulating layer 726 in a region that does not overlap with the electrode 746 may be completely removed. Alternatively, as in a transistor 846 illustrated in FIG. 17C1 and a transistor 847 illustrated in FIG. 17C2, the insulating layer 726 may be left.

In the transistors 842 to 847, after the formation of the electrode 746, the impurity 755 is introduced into the semiconductor layer 742 using the electrode 746 as a mask, so that an impurity region can be formed in the semiconductor layer 742 in a self-aligned manner. According to one embodiment of the present invention, a transistor with favorable electrical characteristics can be provided. Furthermore, according to one embodiment of the present invention, a semiconductor device having a high degree of integration can be provided.

### Embodiment 3

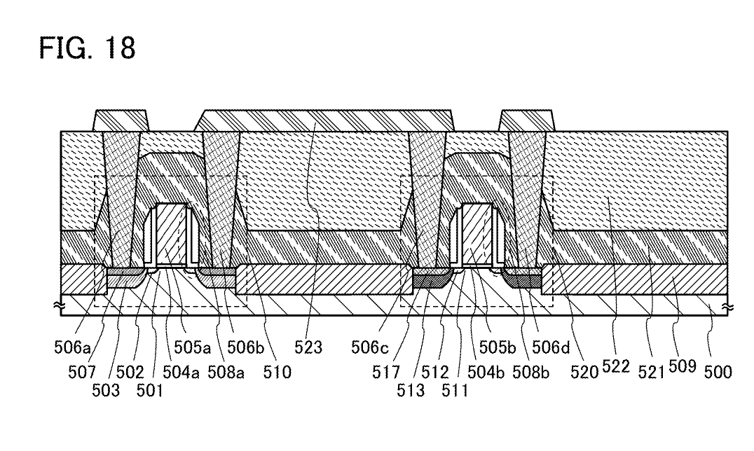

In this embodiment, an example of a cross-sectional structure of a semiconductor device in one embodiment of the present invention will be described with reference FIG. 18.

The semiconductor device described in the above embodiment includes the controller 102, the data register 104, and the digital analog converter 106, and the like. These circuits can be formed using transistors containing silicon or the like. As silicon, polycrystalline silicon, microcrystalline silicon, or amorphous silicon can be used. Note that an oxide semiconductor or the like can be used instead of silicon.

FIG. 18 is a schematic cross-sectional view of a semiconductor device of one embodiment of the present invention. The semiconductor device in the schematic cross-sectional view of FIG. 18 includes an n-channel transistor and a p-channel transistor that contain a semiconductor material (e.g., silicon).

An n-channel transistor 510 includes a channel formation region 501 in a substrate 500 containing a semiconductor material, low-concentration impurity regions 502 and high-concentration impurity regions 503 (collectively referred to simply as impurity regions in some cases) with the channel formation region 501 placed between the impurity regions, intermetallic compound regions 507 in contact with the impurity regions, a gate insulating film 504a over the channel formation region 501, a gate electrode layer 505a over the gate insulating film 504a, and a source electrode layer 506a and a drain electrode layer 506b in contact with the intermetallic compound regions 507. A sidewall insulating film 508a is provided on a side surface of the gate electrode layer 505a. An interlayer insulating film 521 and an interlayer insulating film 522 are provided to cover the transistor 510. The source electrode layer 506a and the drain electrode layer 506b are connected to the intermetallic compound regions 507 through openings formed in the interlayer insulating films 521 and 522.

A p-channel transistor 520 includes a channel formation region 511 in the substrate 500 containing the semiconductor material, low-concentration impurity regions 512 and high-concentration impurity regions 513 (collectively referred to simply as impurity regions in some cases) with the channel formation region 511 placed between the impurity regions, intermetallic compound regions 517 in contact with the impurity regions, a gate insulating film 504b over the channel formation region 511, a gate electrode layer 505b over the gate insulating film 504b, and a source electrode layer 506c and a drain electrode layer 506d in contact with the intermetallic compound regions 517. A sidewall insulating film 508b is provided on a side surface of the gate electrode layer 505b. The interlayer insulating films 521 and 522 are provided to cover the transistor 520. The source electrode layer 506c and the drain electrode layer 506d are connected to the intermetallic compound regions 517 through openings formed in the interlayer insulating films 521 and 522.

An element isolation insulating film 509 is provided in the substrate 500 to surround the transistors 510 and 520.

Although FIG. 18 shows the case where the channels of the transistors 510 and 520 are formed in the semiconductor substrate, the channels of the transistors 510 and 520 may be formed in an amorphous semiconductor film or a polycrystalline semiconductor film formed over an insulating surface. Alternatively, the channels of the transistors may be formed in a single crystal semiconductor film, as in the case of using an SOI substrate.

When the transistors 510 and 520 are formed using a single crystal semiconductor substrate, the transistors 510 and 520 can operate at high speed. Accordingly, a single crystal semiconductor substrate is preferably used for transistors that form each circuit in the above embodiment.

The transistor 510 is connected to the transistor 520 through a wiring 523. It is possible to employ a structure where an interlayer insulating film and an electrode layer are provided over the wiring 523 and another transistor is stacked over them.

### Embodiment 4

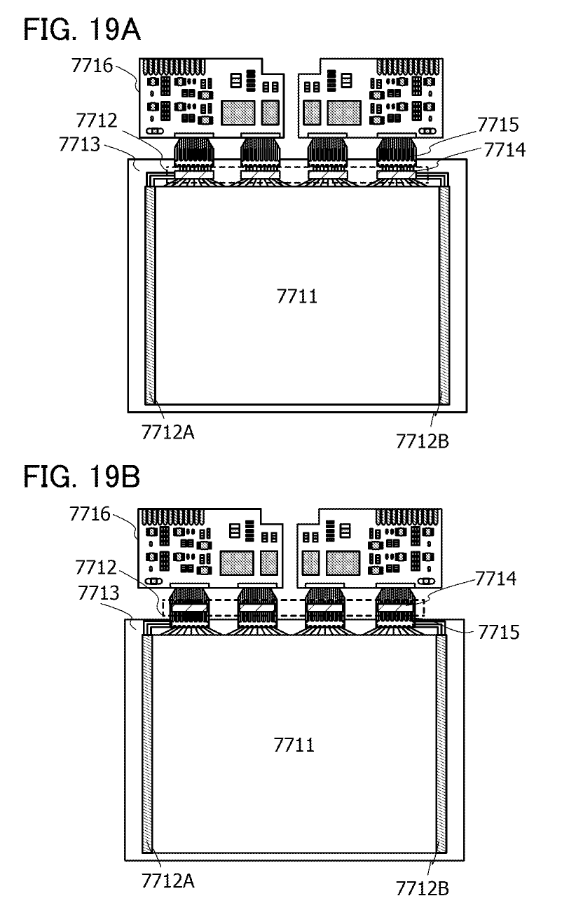

In this embodiment, an application example of the semiconductor device described in the foregoing embodiments to a display panel, application examples of the display panel to a display module, an application example of the display module, and application examples of the display module to an electronic device will be described with reference to FIGS. 19A and 19B, FIG. 20, and FIGS. 21A to 21E.

### <Examples of Mounting Semiconductor Device on Display Panel>

An example of mounting the semiconductor device on a display panel will be described with reference to FIGS. 19A and 19B.

FIG. 19A illustrates an example where a source driver 7712 and gate drivers 7712A and 7712B are provided around a display portion 7711 of the display panel and the semiconductor device described in Embodiment 1 is mounted on a substrate 7713 as the source driver 7712.

The source driver IC 7714 is mounted on the substrate 7713 using an anisotropic conductive adhesive and an anisotropic conductive film.

The source driver IC 7714 is connected to an external circuit board 7716 via an FPC 7715.

FIG. 19B illustrates an example where the source driver 7712 and the gate drivers 7712A and 7712B are provided around the display portion 7711 and the source driver IC 7714 is mounted on the FPC 7715 as the source driver 7712.

Mounting the source driver IC 7714 on the FPC 7715 allows a larger display portion 7711 to be provided over the substrate 7713, resulting in a narrower frame.

### <Application Example of Display Module>

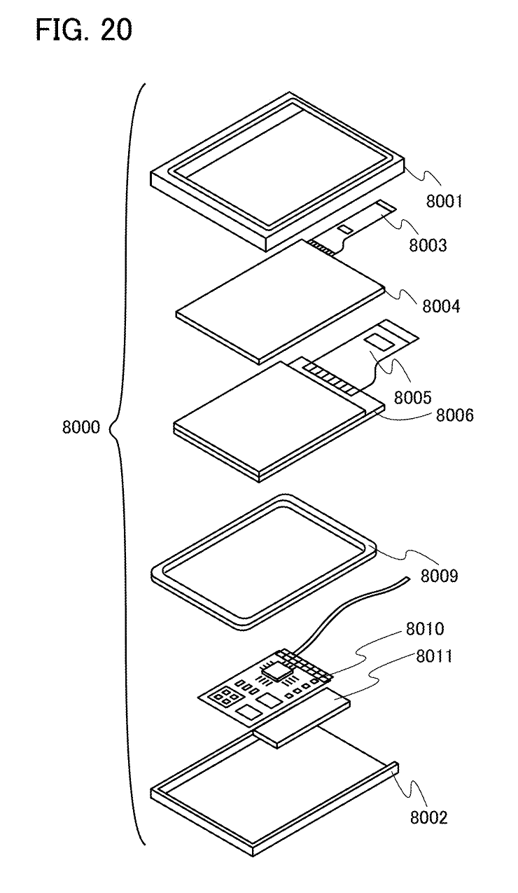

Next, an application example of a display module using the display panel illustrated in FIG. 19A or FIG. 19B will be described with reference to FIG. 20.

In a display module 8000 illustrated in FIG. 20, a touch panel 8004 connected to an FPC 8003, a display panel 8006 connected to an FPC 8005, a frame 8009, a printed board 8010, and a battery 8011 are provided between an upper cover 8001 and a lower cover 8002. Note that the battery 8011, the touch panel 8004, and the like are not provided in some cases.

The display panel illustrated in FIG. 19A or FIG. 19B can be used as the display panel 8006 in FIG. 20.

The shape and size of the upper cover 8001 and the lower cover 8002 can be changed as appropriate in accordance with the size of the touch panel 8004 and the display panel 8006.

The touch panel 8004 can be a resistive touch panel or a capacitive touch panel and can be formed to overlap with the display panel 8006. It is also possible to provide a touch panel function for a counter substrate (sealing substrate) of the display panel 8006. Alternatively, a photosensor may be provided in each pixel of the display panel 8006 so that an optical touch panel is obtained. Further alternatively, an electrode for a touch sensor may be provided in each pixel of the display panel 8006 so that a capacitive touch panel is obtained. In such cases, the touch panel 8004 can be omitted.

The frame 8009 protects the display panel 8006 and functions as an electromagnetic shield for blocking electromagnetic waves generated by the operation of the printed circuit board 8010. The frame 8009 may also function as a radiator plate.

The printed circuit board 8010 is provided with a power supply circuit and a signal processing circuit for outputting gradation data and a clock signal. As a power source for supplying power to the power supply circuit, an external commercial power source or a separate power source using the battery 8011 may be used. The battery 8011 can be omitted in the case of using a commercial power source.

The display module 8000 can be additionally provided with a member such as a polarizing plate, a retardation plate, or a prism sheet.

[symbol]

Touch Panel

[symbol]

An example of a touch panel including an input device (touch sensor) applicable to a display device of one embodiment of the present invention is described.

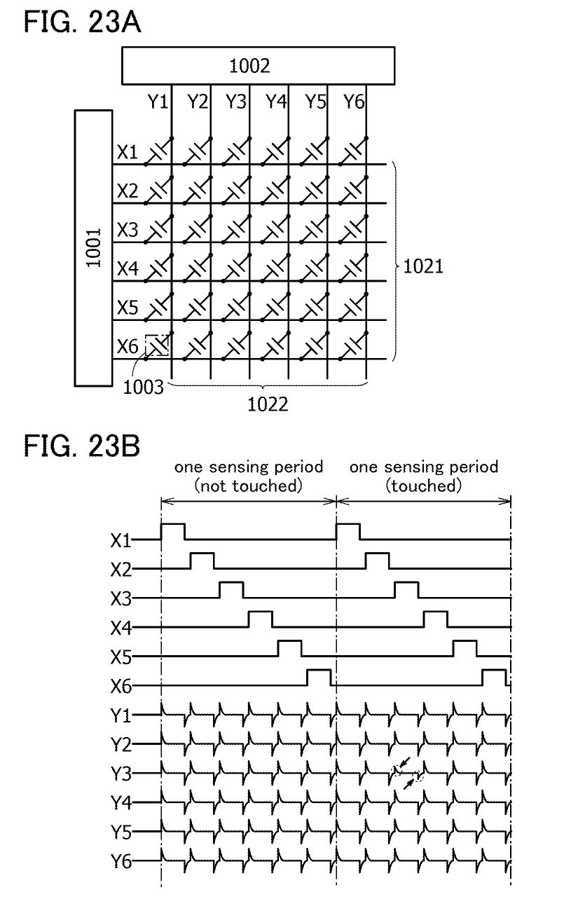

FIG. 23A is a block diagram illustrating the structure of a mutual capacitive touch sensor. FIG. 23A illustrates a pulse voltage output circuit 1001 and a current sensing circuit 1002. Note that in FIG. 23A, six wirings X1 to X6 represent electrodes 1021 to which a pulse voltage is applied, and six wirings Y1 to Y6 represent electrodes 1022 that sense changes in current. The number of the electrodes is not limited to this. FIG. 23A also illustrates a capacitor 1003 that is formed with the electrodes 1021 and 1022 overlapping with each other or being provided close to each other. Note that the functions of the electrodes 1021 and 1022 can be interchanged with each other.

The pulse voltage output circuit 1001 is, for example, a circuit for sequentially inputting a pulse voltage to the wirings X1 to X6. The current sensing circuit 1002 is, for example, a circuit for sensing current flowing through each of the wirings Y1-Y6.

By application of a pulse voltage to one of the wirings X1 to X6, an electric field is generated between the electrodes 1021 and 1022 of the capacitor 1003, and current flows through the electrode 1022. Part of the electric field generated between the electrodes is blocked when an object such a finger or a stylus contacts or approaches the device, so that the electric field intensity between the electrodes is changed. Consequently, the amount of current flowing through the electrode 1022 is changed.

For example, in the case where there is no approach or no contact of an object, the amount of current flowing in each of the wirings Y1-Y6 depends on the amount of capacitance of the capacitor 1003. In the case where part of an electric field is blocked by the approach or contact of an object, a decrease in the amount of current flowing in the wirings Y1-Y6 is sensed. The approach or contact of an object can be sensed by utilizing this change.

Sensing by the current sensing circuit 1002 may be performed using an integral value (time integral value) of current flowing in a wiring. In that case, sensing may be performed with an integrator circuit or the like, for example. Alternatively, the peak value of current may be sensed. In that case, for example, current may be converted into voltage, and the peak voltage value may be sensed.

FIG. 23B is an example of a timing chart illustrating input and output waveforms in the mutual capacitive touch sensor in FIG. 23A. In FIG. 23B, sensing in each row and each column is performed in one sensing period. FIG. 23B shows a period when the contact or approach of an object is not sensed (when the touch sensor is not touched) and a period when the contact or approach of an object is sensed (when the touch sensor is touched). Here, the wirings Y1-Y6 each show a waveform of a voltage corresponding to the amount of current to be sensed.

As shown in FIG. 23B, the wirings X1-X6 are sequentially supplied with a pulse voltage. Accordingly, current flows in the wirings Y1-Y6. When the touch sensor is not touched, substantially the same current flows in the wirings Y1-Y6 in accordance with a change in voltages of the wirings X1-X6; thus, the wirings Y1-Y6 have similar output waveforms. Meanwhile, when the touch sensor is touched, current flowing in a wiring in a position which an object contacts or approaches among the wirings Y1-Y6 is reduced; thus, the output waveforms are changed as shown in FIG. 23B.

FIG. 23B shows an example in which an object contacts or approaches the intersection of the wiring X3 and the wiring Y3 or the vicinity thereof.

A change in current due to block of an electric field generated between a pair of electrodes is sensed in this manner in a mutual capacitive touch sensor, so that positional information of an object can be obtained. When the detection sensitivity is high, the coordinates of the object can be determined even when the object is far from a detection surface (e.g., a surface of the touch panel).

By driving a touch panel by a method in which a display period of a display portion and a sensing period of a touch sensor do not overlap with each other, the detection sensitivity of the touch sensor can be increased. For example, a display period and a sensing period may be separately provided in one display frame period. In that case, two or more sensing periods are preferably provided in one frame period. When the frequency of sensing is increased, the detection sensitivity can be increased.

It is preferable that, as an example, the pulse voltage output circuit 1001 and the current sensing circuit 1002 be formed in one IC chip. For example, the IC is preferably mounted on a touch panel or a substrate in a housing of an electronic device. In the case where the touch panel has flexibility, parasitic capacitance might be increased in a bent portion of the touch panel, and the influence of noise might be increased. In view of this, it is preferable to use an IC to which a driving method less influenced by noise is applied. For example, it is preferable to use an IC to which a driving method capable of increasing a signal-noise ratio (S/N ratio) is applied.

### <Usage Example in Electronic Device>

Next, an electronic device having a display panel including the above display module will be described. Examples of the electronic device include a computer, a portable information terminal (including a mobile phone, a portable game machine, and an audio reproducing device), electronic paper, a television device (also referred to as television or television receiver), and a digital video camera.

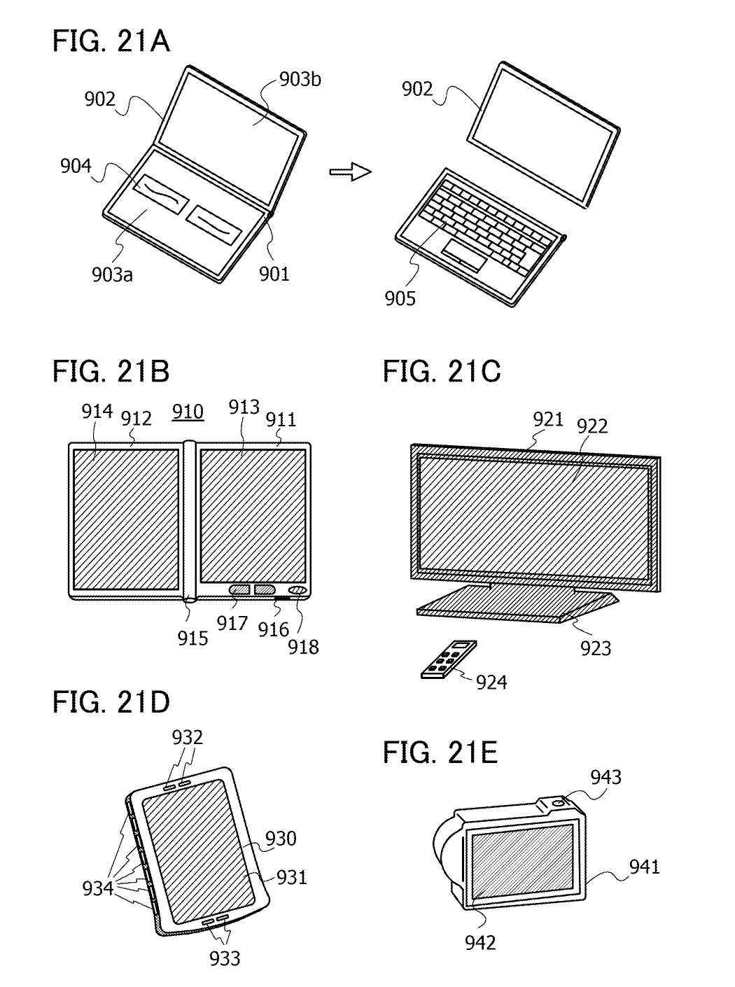

FIG. 21A illustrates a portable information terminal, which includes a housing 901, a housing 902, a first display portion 903a, a second display portion 903b, and the like. At least one of the housings 901 and 902 is provided with a display module including the semiconductor device described in the above embodiment. It is thus possible to obtain a portable information terminal with a smaller circuit area and improved display quality.

The first display portion 903a is a panel having a touch input function, and for example, as illustrated in the left of FIG. 21A, which of “touch input” and “keyboard input” is performed can be selected by a selection button 904 displayed on the first display portion 903a. Since selection buttons with a variety of sizes can be displayed, the portable information terminal can be easily used by people of any generation. For example, when “keyboard input” is selected, a keyboard 905 is displayed on the first display portion 903a as illustrated in the right of FIG. 21A. Thus, letters can be input quickly by keyboard input as in a conventional information terminal, for example.

One of the first display portion 903a and the second display portion 903b can be detached from the portable information terminal as illustrated in the right of FIG. 21A. Providing the second display portion 903b with a touch input function makes the portable information terminal convenient to carry because a weight to carry around can be further reduced and the portable information terminal can operate with one hand while the other hand supports the housing 902.

The portable information terminal in FIG. 21A can be equipped with a function of displaying a variety of information (e.g., a still image, a moving image, and a text image); a function of displaying a calendar, a date, the time, or the like on the display portion; a function of operating or editing information displayed on the display portion; a function of controlling processing by various kinds of software (programs); and the like. Furthermore, an external connection terminal (an earphone terminal, a USB terminal, or the like), a recording medium insertion portion, and the like may be provided on the back surface or the side surface of the housing.

The portable information terminal illustrated in FIG. 21A may transmit and receive data wirelessly. Through wireless communication, desired book data or the like can be purchased and downloaded from an e-book server.

Furthermore, the housing 902 in FIG. 21A may be equipped with an antenna, a microphone function, and a wireless communication function to be used as a mobile phone.

FIG. 21B illustrates an e-book reader 910 including electronic paper. The e-book reader 910 includes two housings 911 and 912. The housing 911 and the housing 912 are provided with a display portion 913 and a display portion 914, respectively. The housings 911 and 912 are connected by a hinge portion 915 and can be opened and closed with the hinge portion 915 as an axis. The housing 911 is provided with a power switch 916, an operation key 917, a speaker 918, and the like. The display module including the semiconductor device of the foregoing embodiment is provided in at least one of the housings 911 and 912. It is thus possible to obtain an e-book reader with a smaller circuit area and improved display quality.

FIG. 21C illustrates a television device including a housing 921, a display portion 922, a stand 923, and the like. The television device 920 can operate with a switch of the housing 921 and a separate remote controller 924. A display module including the semiconductor device of the foregoing embodiment is mounted on the housing 921 and the remote controller 924. Thus, it is possible to obtain a television device with a smaller circuit area and improved display quality.

FIG. 21D illustrates a smartphone in which a main body 930 is provided with a display portion 931, a speaker 932, a microphone 933, an operation button 934, and the like. A display module including the semiconductor device of the foregoing embodiment is provided in the main body 930. It is thus possible to obtain a smartphone with a smaller circuit area and improved display quality.

FIG. 21E illustrates a digital camera including a main body 941, a display portion 942, an operation switch 943, and the like. A display module including the semiconductor device of the foregoing embodiment is provided in the main body 941. Consequently, it is possible to obtain a digital camera with a smaller circuit area and improved display quality.

As described above, a display module including the semiconductor device described in the above embodiment is provided in the electronic device shown in this embodiment. It is thus possible to obtain an electronic device with a smaller circuit area and improved display quality.

(Notes on Description in this Specification and the Like)

The following are notes on the description of the above embodiments and structures in the embodiments.

### <Notes on One Embodiment of the Present Invention Described in Embodiments>

One embodiment of the present invention can be constituted by appropriately combining the structure described in an embodiment with any of the structures described in the other embodiments. In addition, in the case where a plurality of structure examples are described in one embodiment, any of the structure examples can be combined as appropriate.

Note that a content (or part thereof) described in one embodiment can be applied to, combined with, or replaced with another content (or part thereof) described in the same embodiment and/or a content (or part thereof) described in another embodiment or other embodiments.

Note that in each embodiment, a content described in the embodiment is a content described with reference to a variety of diagrams or a content described with a text in this specification.

By combining a diagram (or part thereof) described in one embodiment with another part of the diagram, a different diagram (or part thereof) described in the embodiment, and/or a diagram (or part thereof) described in another embodiment or other embodiments, much more diagrams can be formed.

### <Notes on Description for Drawings>

In this specification and the like, terms for describing arrangement, such as “over” and “under”, are used for convenience to indicate a positional relationship between components with reference to drawings. The positional relationship between components is changed as appropriate in accordance with a direction in which the components are described. Therefore, the terms for explaining arrangement are not limited to those used in this specification and may be changed to other terms as appropriate depending on the situation.

The term “over” or “below” does not necessarily mean that a component is placed directly on or directly below and directly in contact with another component. For example, the expression “electrode B over insulating layer A” does not necessarily mean that the electrode B is on and in direct contact with the insulating layer A and can also mean the case where another component is provided between the insulating layer A and the electrode B.

Furthermore, in a block diagram in this specification and the like, components are functionally classified and shown by blocks that are independent of each other. However, in an actual circuit and the like, such components are sometimes hard to classify functionally, and there is a case where one circuit is associated with a plurality of functions or a case where a plurality of circuits are associated with one function. Therefore, the segmentation of blocks in a block diagram is not limited by any of the components described in the specification and can be differently determined as appropriate depending on the situation.

In the drawings, the size, the layer thickness, or the region is determined arbitrarily for description convenience; therefore, embodiments of the present invention are not limited to such a scale. Note that the drawings are schematically shown for clarity, and embodiments of the present invention are not limited to shapes or values shown in the drawings. For example, the following can be included: variation in signal, voltage, or current due to noise or difference in timing.

<Notes on Expressions that can be Rephrased>

In this specification and the like, the terms “one of a source and a drain” (or first electrode or first terminal) and “the other of the source and the drain” (or second electrode or second terminal) are used to describe the connection relationship of a transistor. This is because a source and a drain of a transistor are interchangeable depending on the structure, operation conditions, or the like of the transistor. Note that the source or the drain of the transistor can also be referred to as a source (or drain) terminal, a source (or drain) electrode, or the like as appropriate depending on the situation.

In addition, in this specification and the like, the term such as “electrode” or “wiring” does not limit a function of a component. For example, an “electrode” is used as part of a “wiring” in some cases, and vice versa. Moreover, the term “electrode” or “wiring” can also mean a combination of a plurality of electrodes or wirings formed in an integrated manner.

In this specification and the like, “voltage” and “potential” can be replaced with each other. The term “voltage” refers to a potential difference from a reference potential. When the reference potential is a ground voltage, for example, “voltage” can be replaced with “potential”. The ground potential does not necessarily mean 0 V. Potentials are relative values, and a potential supplied to a wiring or the like is sometimes changed depending on the reference potential.

In this specification and the like, the terms “film” and “layer” can be interchanged with each other depending on the case or circumstances. For example, the term “conductive layer” can be changed into the term “conductive film” in some cases. Moreover, the term “insulating film” can be changed into the term “insulating layer” in some cases.

This specification and the like show a 1T-1C circuit structure where one pixel has one transistor and one capacitor and a 2T-1C circuit structure where one pixel has two transistors and one capacitor; however, this specification and the like are not limited to these. It is possible to employ a circuit configuration where one pixel includes three or more transistors and two or more capacitors. Moreover, a variety of circuit structures can be obtained by formation of an additional wiring.

### <Notes on Definitions of Terms>

The following are definitions of the terms not mentioned in the above embodiments.

### <<Switch>>

In this specification and the like, a switch is in a conductive state (on state) or in a non-conductive state (off state) to determine whether current flows therethrough or not. Alternatively, a switch has a function of selecting and changing a current path.

Examples of a switch are an electrical switch, a mechanical switch, and the like. That is, any element can be used as a switch as long as it can control current, without limitation to a certain element.

Examples of the electrical switch are a transistor (e.g., a bipolar transistor or a MOS transistor), a diode (e.g., a PN diode, a PIN diode, a Schottky diode, a metal-insulator-metal (MIM) diode, a metal-insulator-semiconductor (MIS) diode, or a diode-connected transistor), and a logic circuit in which such elements are combined.

In the case of using a transistor as a switch, an “on state” of the transistor refers to a state in which a source and a drain of the transistor are electrically short-circuited. Furthermore, an “off state” of the transistor refers to a state in which the source and the drain of the transistor are electrically disconnected. In the case where a transistor operates just as a switch, the polarity (conductivity type) of the transistor is not particularly limited to a certain type.

An example of the mechanical switch is a switch formed using a micro electro mechanical systems (MEMS) technology, such as a digital micromirror device (DMD). Such a switch includes an electrode which can be moved mechanically, and operates by controlling conduction and non-conduction in accordance with movement of the electrode.

### <<Channel Length>>

In this specification and the like, the channel length refers to, for example, a distance between a source and a drain in a region where a semiconductor (or a portion where a current flows in a semiconductor when a transistor is on) and a gate overlap with each other or a region where a channel is formed in a plan view of the transistor.

In one transistor, channel lengths in all regions are not necessarily the same. In other words, the channel length of one transistor is not fixed to one value in some cases. Therefore, in this specification, the channel length is any one of values, the maximum value, the minimum value, or the average value, in a region where a channel is formed.

### <<Channel Width>>

In this specification and the like, the channel width refers to, for example, the length of a portion where a source and a drain face each other in a region where a semiconductor (or a portion where a current flows in a semiconductor when a transistor is on) and a gate electrode overlap with each other, or a region where a channel is formed.

In one transistor, channel widths in all regions are not necessarily the same. In other words, the channel width of one transistor is not fixed to one value in some cases. Therefore, in this specification, the channel width is any one of values, the maximum value, the minimum value, or the average value, in a region where a channel is formed.

Note that depending on transistor structures, a channel width in a region where a channel is formed actually (hereinafter referred to as an effective channel width) is different from a channel width shown in a top view of the transistor (hereinafter referred to as an apparent channel width) in some cases. For example, in a transistor having a three-dimensional structure, an effective channel width is greater than an apparent channel width shown in a top view of the transistor, and its influence cannot be ignored in some cases. For example, in a miniaturized transistor having a three-dimensional structure, the proportion of a channel region formed in a side surface of a semiconductor is high in some cases. In that case, an effective channel width obtained when a channel is actually formed is greater than an apparent channel width shown in the top view.

In a transistor having a three-dimensional structure, an effective channel width is difficult to measure in some cases. For example, estimation of an effective channel width from a design value requires an assumption that the shape of a semiconductor is known. Therefore, in the case where the shape of a semiconductor is not known accurately, it is difficult to measure an effective channel width accurately.

Therefore, in this specification, in a top view of a transistor, an apparent channel width that is a length of a portion where a source and a drain face each other in a region where a semiconductor and a gate electrode overlap with each other is referred to as a surrounded channel width (SCW) in some cases. Furthermore, in this specification, in the case where the term “channel width” is simply used, it may represent a surrounded channel width or an apparent channel width. Alternatively, in this specification, in the case where the term “channel width” is simply used, it may represent an effective channel width in some cases. Note that the values of a channel length, a channel width, an effective channel width, an apparent channel width, a surrounded channel width, and the like can be determined by obtaining and analyzing a cross-sectional TEM image and the like.

Note that in the case where field-effect mobility, a current value per channel width, and the like of a transistor are obtained by calculation, a surrounded channel width may be used for the calculation. In that case, the values may be different from those calculated using an effective channel width in some cases.

### <<Pixel>>

In this specification and the like, one pixel refers to one element whose brightness can be controlled, for example. Therefore, for example, one pixel corresponds to one color element by which brightness is expressed. Accordingly, in a color display device using color elements of red (R), green (G), and blue (B), the smallest unit of an image is formed of three pixels of an R pixel, a G pixel, and a B pixel.

Note that the number of colors for color elements is not limited to three, and more colors may be used. For example, RGBW (W: white) or RGB added with yellow, cyan, or magenta may be employed.

### <<Display Element>>

In this specification and the like, a display element includes a display medium whose contrast, luminance, reflectivity, transmittance, or the like is changed by electrical or magnetic effect. Examples of the display element include an electroluminescent (EL) element, an LED chip (e.g., a white LED chip, a red LED chip, a green LED chip, and a blue LED chip), a transistor (a transistor that emits light depending on current), an electron emitter, a display element using a carbon nanotube, a liquid crystal element, electronic ink, an electrowetting element, an electrophoretic element, a plasma display panel (PDP), a display element using microelectromechanical systems (MEMS) (e.g., a grating light valve (GLV), a digital micromirror device (DMD), a digital micro shutter (DMS), Mirasol (registered trademark), an interferometric modulator display (IMOD) element, a MEMS shutter display element, an optical-interference-type MEMS display element, and a piezoelectric ceramic display), a carbon nanotube, and quantum dots. Examples of a display device having an EL element include an EL display. Examples of display devices having electron emitters include a field emission display (FED), an SED-type flat panel display (SED: surface-conduction electron-emitter display), and the like. Examples of display devices including liquid crystal elements include a liquid crystal display (e.g., a transmissive liquid crystal display, a transflective liquid crystal display, a reflective liquid crystal display, a direct-view liquid crystal display, or a projection liquid crystal display). Examples of a display device including electronic ink, electronic liquid powder (registered trademark), or electrophoretic elements include electronic paper. Examples of display devices containing quantum dots in each pixel include a quantum dot display. Note that quantum dots may be provided not as display elements but as part of a backlight. The use of quantum dots enables display with high color purity. In the case of a transflective liquid crystal display or a reflective liquid crystal display, some or all of pixel electrodes may serve as reflective electrodes. For example, some or all of pixel electrodes may contain aluminum, silver, or the like. In such a case, a memory circuit such as an SRAM can be provided under the reflective electrodes, leading to lower power consumption. Note that in the case of using an LED chip, graphene or graphite may be provided under an electrode or a nitride semiconductor of the LED chip. Graphene or graphite may be a multilayer film in which a plurality of layers are stacked. When graphene or graphite is provided in this manner, a nitride semiconductor, for example, an n-type GaN semiconductor layer including crystals can be easily formed thereover. Furthermore, a p-type GaN semiconductor layer including crystals or the like can be provided thereover, and thus the LED chip can be formed. Note that an AlN layer may be provided between the n-type GaN semiconductor layer including crystals and graphene or graphite. The GaN semiconductor layers included in the LED chip may be formed by MOCVD. Note that when the graphene is provided, the GaN semiconductor layers included in the LED chip can also be formed by a sputtering method. In the case of a display element including MEMS, a drying agent may be provided in a space where the display element is sealed (or between an element substrate over which the display element is placed and a counter substrate opposed to the element substrate, for example). Providing a drying agent can prevent MEMS and the like from becoming difficult to move or deteriorating easily because of moisture or the like.

### <<Connection>>

In this specification and the like, the expression “A and B are connected” or “A is connected to B” means the case where A and B are electrically connected to each other as well as the case where A and B are directly connected to each other. Here, the expression “A and B are electrically connected” means the case where electric signals can be transmitted and received between A and B when an object having any electric action exists between A and B.

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

Examples of the expressions include “X, Y, and a source (or a first terminal or the like) and a drain (or a second terminal or the like) of a transistor are electrically connected to each other, and X, the source (or the first terminal or the like) of the transistor, the drain (or the second terminal or the like) of the transistor, and Y are electrically connected to each other in this order,” “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order,” and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order.” When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path,” and “a source (or a first terminal or the like) of a transistor is electrically connected to X through Z1 at least with a first connection path, the first connection path does not include a second connection path, the second connection path includes a connection path through the transistor, a drain (or a second terminal or the like) of the transistor is electrically connected to Y through Z2 at least with a third connection path, and the third connection path does not include the second connection path.” Still another example of the expression is “a source (or a first terminal or the like) of a transistor is electrically connected to X through Z1 on at least a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through Z2 on at least a third electrical path, the third electrical path does not include a fourth electrical path, and the fourth electrical path is an electrical path from the drain (or the second terminal or the like) of the transistor to the source (or the first terminal or the like) of the transistor.” When the connection path in a circuit configuration is defined by an expression similar to the above examples, a source (or a first terminal or the like) and a drain (or a second terminal or the like) of a transistor can be distinguished from each other to specify the technical scope.

Note that one embodiment of the present invention is not limited to these expressions which are just examples. Here, each of X, Y, Z1, and Z2 denotes an object (e.g., a device, an element, a circuit, a wiring, an electrode, a terminal, a conductive film, a layer, or the like).

### REFERENCE NUMERALS

M1: transistor, M2: transistor, M3: transistor, 100: semiconductor device, 100A: semiconductor device, 100B: semiconductor device, 100D: semiconductor device, 102: controller, 103: shift register, 104: data register, 104A: data register, 104B: data register, 105: level shifter, 106: digital analog converter, 106A: digital analog converter, 106B: digital analog converter, 107: output buffer, 108: pixel portion, 109: demultiplexer, 110: sensor, 110A: sensor, 110B: sensor, 110D: sensor, 112: photoelectric conversion element, 112B: photodiode, 112G: photodiode, 112R: photodiode, 113: amplifier, 114: current-voltage converter circuit, 115: resistor, 116: analog digital converter, 120: processor, 130A: look up table, 130B: look up table, 141: frame memory, 140: arithmetic circuit, 150: external circuit board, 152: serial-parallel conversion circuit, 154: LVDS receiver, 156: LVDS transmitter, 160: memory device, 170: external communication means, 500: substrate, 501: channel formation region, 502: low-concentration impurity region, 503: high-concentration impurity region, 504a: gate insulating film, 504b: gate insulating film, 505a: gate electrode layer, 505b: gate electrode layer, 506a: source electrode layer, 506b: drain electrode layer, 506c: source electrode layer, 506d: drain electrode layer, 507: intermetallic compound region, 508a: sidewall insulating film, 508b: sidewall insulating film, 509: element isolation insulating film, 510: transistor, 511: channel formation region, 512: low-concentration impurity region, 513: high-concentration impurity region, 517: intermetallic compound region, 520: transistor, 521: interlayer insulating film, 522: interlayer insulating film, 523: wiring, 601: pixel portion, 602: gate line driver circuit, 603: gate line driver circuit, 604: signal line driver circuit, 605: pixel, 605A: pixel, 605B: pixel, 605C: pixel, 605D: pixel, 611: display element, 612: display element, 621: layer, 622: layer, 623: layer, 631: substrate, 632: substrate, 633: light-emitting layer, 634: electrode, 635: electrode, 636: color filter, 637: conductive layer, 638: conductive layer, 639: liquid crystal, 640: conductive layer, 641: color filter, 651: adhesive layer, 652: insulating layer, 653: insulating layer, 654: insulating layer, 655: insulating layer, 656: insulating layer, 657: insulating layer, 658: insulating layer, 659: insulating layer, 660: alignment film, 661: alignment film, 662: light-blocking film, 663: conductive layer, 664: conductive layer, 665: insulating layer, 670: connection portion, 671: connection layer, 672: FPC, 673: adhesive layer, 680: transistor, 690: connection portion, 691: connector, 705: insulating layer, 706: electrode, 707: insulating layer, 708: semiconductor layer, 710: insulating layer, 711: insulating layer, 714: electrode, 715: electrode, 722: insulating layer, 723: electrode, 726: insulating layer, 727: insulating layer, 728: insulating layer, 729: insulating layer, 741: insulating layer, 742: semiconductor layer, 744a: electrode, 744b: electrode, 746: electrode, 755: impurity, 771: substrate, 772: insulating layer, 810: transistor, 811: transistor, 820: transistor, 821: transistor, 825: transistor, 830: transistor, 831: transistor, 840: transistor, 841: transistor, 842: transistor, 843: transistor, 844: transistor, 845: transistor, 846: transistor, 847: transistor, 901: housing, 902: housing, 903a: display portion, 903b: display portion, 904: selection button, 905: keyboard, 910: e-book reader, 911: housing, 912: housing, 913: display portion, 914: display portion, 915: hinge portion, 916: power switch, 917: operation key, 918: speaker, 920: television device, 921: housing, 922: display portion, 923: stand, 924: separate remote controller, 930: main body, 931: display portion, 932: speaker, 933: microphone, 934: operation button, 941: main body, 942: display portion, 943: operation switch, 7711: display portion, 7712: source driver, 7712A: gate driver, 7712B: gate driver, 7713: substrate, 7714: source driver IC, 7715: FPC, 7716: external circuit board, 8000: display module, 8001: upper cover, 8002: lower cover, 8003: FPC, 8004: touch panel, 8005: FPC, 8006: display panel, 8009: frame, 8010: printed circuit board, 8011: battery

This application is based on Japanese Patent Application serial no. 2015-200272 filed with Japan Patent Office on Oct. 8, 2015, the entire contents of which are hereby incorporated by reference.

1. A semiconductor device comprising:
a first circuit;
a second circuit; and
a third circuit,
wherein:
the first circuit is configured to generate a third signal and a fourth signal in accordance with a first signal and a second signal,
the second circuit is configured to hold the third signal and the fourth signal,
the third circuit is configured to execute digital-to-analog conversion of the third signal and the fourth signal,
the first signal is illuminance data,
the second signal is gradation data,
the third signal is liquid crystal gradation data for driving a liquid crystal element, and
the fourth signal is light-emitting element gradation data for driving a light-emitting element.

2. A semiconductor device comprising:
a first circuit;
a second circuit; and
a third circuit,
wherein:
the first circuit is configured to generate a third signal and a fourth signal in accordance with a first signal and a second signal,
the second circuit is configured to hold the third signal and the fourth signal,
the third circuit is configured to execute digital-to-analog conversion of the third signal and the fourth signal,
the first signal is illuminance data,
the second signal is gradation data,
the third signal is liquid crystal gradation data for driving a liquid crystal element,
the fourth signal is light-emitting element gradation data for driving a light-emitting element, and
the first circuit is configured to vary a ratio of luminance based on the liquid crystal gradation data to luminance based on the light-emitting element gradation data depending on a size of the illuminance data.

3. A semiconductor device comprising:
a first circuit;
a second circuit; and
a third circuit,
wherein:
the first circuit is configured to generate a third signal and a fourth signal in accordance with a first signal and a second signal,
the second circuit is configured to hold the third signal and the fourth signal,
the third circuit is configured to execute digital-to-analog conversion of the third signal and the fourth signal,
the first signal is illuminance data,
the second signal is gradation data,
the third signal is liquid crystal gradation data for driving a liquid crystal element,
the fourth signal is light-emitting element gradation data for driving a light-emitting element, and
the first circuit is configured to estimate designed luminance based on the gradation data, estimate reflected light luminance in accordance with a size of the illuminance data, vary a ratio of luminance based on the liquid crystal gradation data to luminance based on the light-emitting element gradation data in accordance with a magnitude relationship between the designed luminance and the reflected light luminance.

4. A display device comprising:
the semiconductor device according to claim 1; and
a pixel portion,
wherein:
the pixel portion includes a pixel, and
the pixel includes the light-emitting element and the liquid crystal element including a reflective electrode.

5. A display device comprising:
the semiconductor device according to claim 2; and
a pixel portion,
wherein:
the pixel portion includes a pixel, and
the pixel includes the light-emitting element and the liquid crystal element including a reflective electrode.

6. A display device comprising:
the semiconductor device according to claim 3; and
a pixel portion,
wherein:
the pixel portion includes a pixel, and
the pixel includes the light-emitting element and the liquid crystal element including a reflective electrode.

7. The display device according to claim 4,
wherein the liquid crystal element and the light-emitting element are provided to overlap with each other.

8. The display device according to claim 5,
wherein the liquid crystal element and the light-emitting element are provided to overlap with each other.

9. The display device according to claim 6,
wherein the liquid crystal element and the light-emitting element are provided to overlap with each other.

10. An electronic device comprising:
the display device according to claim 4, and
an operation portion.

11. An electronic device comprising:
the display device according to claim 5, and
an operation portion.

12. An electronic device comprising:
the display device according to claim 6, and
an operation portion.
